(19) United States
(12) Patent Application Publication
(10) Pub. No.: US 2013/0291126 A1
(43) Pub. Date: Oct. 31, 2013

(54) Electronic Document Delivery, Display, Updating, and Interaction Systems and Methods

(71) Applicant: David G. Thomson, Overland Park, KS (US)

(72) Inventor: David G. Thomson, Overland Park, KS (US)

(73) Assignee: BLUEPRINT GROWTH INSTITUTE, INC., Overland Park, KS (US)

(21) Appl. No.: 13/157,989

(22) Filed: Jun. 10, 2011

Related U.S. Application Data
(60) Provisional application No. 61/353,831, filed on Jun. 11, 2010.

(51) Int. Cl. G06F 17/30; G06F 21/24; G06F 15/16

(52) U.S. Cl. 726/30; 709/217

(57) ABSTRACT

System and methods for actively updating, revising, and supplementing content of an electronic document, such as a book. A book-like interface with active regions and page links may be utilized. In one example, a method of modifying a remote electronic document in an electronic file with updated information from an active document server or remote service involving connecting an active document reader which resides on a computing device having the electronic file and active document reader to the active document server via a network; identifying one or more subsets of the information in the document file package to be updated; providing via the network a set of updated information for the one or more subsets; and replacing the one or more subsets with the updated information without replacing the entire electronic file.

### RELATED APPLICATION DATA

This application claims the benefit of priority of U.S. Provisional Patent Application Ser. No. 61/353,831, filed Jun. 11, 2010, and titled “Electronic Document Delivery, Display, Updating, and Interaction Systems and Methods,” which is incorporated by reference herein in its entirety.

### SUMMARY OF THE DISCLOSURE

In one implementation, a method of modifying an electronic document with updated information from an active document server, the document including information being in a document file package located on a computing device remote from the active document server, the electronic document file package protected by a rights management system is provided. The method includes connecting an active document reader which resides on a computing device having the document file package and active document reader to the active document server via a network; identifying one or more subsets of the information in the document file package to be updated; providing via the network a set of updated information for the one or more subsets; and replacing the one or more subsets with the updated information without replacing the entire electronic document file package.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a functional block diagram for an active book System 100 in accordance with the invention.

FIG. 2 illustrates a flow diagram for a method 200 for providing active content in an active book System 100.

FIG. 3 illustrates a functional diagram for prescriptive downloading active book content in an Active Book System 100.

FIG. 3a illustrates an expanded view of an example page of prescriptively downloading an active book.

FIG. 4 illustrates a flow diagram for a method 400 for prescriptive downloading active book content in an Active Book System 100.

FIG. 5 illustrates a functional diagram for real time data downloading in an Active Book System 100.

FIG. 5a illustrates an expanded view of an example page of real-time downloading an active book.

FIG. 6 illustrates a flow diagram for a method 600 for downloading real time data in an Active Book System 100.

FIG. 7 illustrates a functional diagram for financial transactions in an Active Book System 100.

FIG. 7a illustrates an expanded view of an example page of a financial transaction in an active book.

FIG. 8 illustrates a flow diagram for a method 800 for conducting financial transactions in an Active Book System 100.

FIG. 9 illustrates a functional diagram for subscription service in an Active Book System 100.

FIG. 9a illustrates an expanded view of an example page of a subscription service in an active book.

FIG. 10 illustrates a flow diagram for a method 1000 for creating a subscription service in an Active Book System 100.

FIG. 11 illustrates a functional diagram for advertising in an Active Book System 100.

FIG. 11a illustrates an expanded view of an example page of advertising in an active book.

FIG. 12 illustrates a flow diagram for a method 1200 for creating advertising in an Active Book System 100.

FIG. 13 illustrates a functional diagram for shareable notes across electronic books in an Active Book System 100.

FIG. 13a illustrates an expanded view of an example page of sharing notes across electronic books in an active book.

FIG. 14 illustrates a flow diagram for a method 1400 for sharing notes across electronic books in an Active Book System 100.

FIG. 15 illustrates a functional diagram for Excerpt for Social Media in an Active Book System 100.

FIG. 15b illustrates a flow diagram for a method 1500 for excerpts across electronic books in an Active Book System 100.

FIG. 16 illustrates a functional diagram for a Resource Page in an Active Book System 100.

FIG. 16a illustrates an expanded view of an example page of a resource page in an active book.

FIG. 17 illustrates a functional diagram for a business model in an Active Book System 100.

FIG. 17b illustrates a flow diagram for a business method 1700 in an Active Book System 100.

### DETAILED DESCRIPTION

The present disclosure provides systems and methods for an enhanced electronic document (e.g., an enhanced electronic book) delivery, display, updating, and interaction. An electronic document (e.g., an electronic book accessed through an electronic book reader) according to the present disclosure is utilized by a user on a computing device (e.g. tablet, laptop). The computing device may be connected to a document server (e.g., the Active Book Server discussed further below) via a network. Example networks and computing devices for a user computing device and a server are discussed further below (e.g., with respect to FIG. 18). An electronic document for purposes of this disclosure is a document which includes textual, graphical, chart, hyperlinks, interactive video, frequently updated alerts or stock prices, and/or other content that is packaged in an electronic file package. Prior art electronic documents are static in nature (i.e., they are static electronic documents) and are incapable of being updated after the release date or publish date of the electronic document. As discussed more fully below, the electronic document delivery, display, updating and interaction systems and methods disclosed herein, provide for active interaction (e.g., active updating) of electronic documents. For example, electronic documents can be updated in real time and/or periodically by an Active Book Server associated with a given active electronic document. An electronic document being interacted with (e.g., being updated) may originally be a static document or may originally be an active document. Exemplary electronic documents, an Active Book and Active Electronic Document, are discussed further below.

The subject matter of the electronic document may be protected by copyright. The content of the electronic document may be provided under an agreement (e.g., with an author, publisher, corporate document provider, distributor) that limits one or more of the aspects of the electronic document. Example aspects of an electronic document that may be limited include, but are not limited to, distribution restrictions (e.g., restrictions on redistribution), copy restrictions, access restrictions, and other restrictions. A rights management system may be utilized to manage and/or restrict the copying, redistribution, and/or other access to the content of the electronic document. In one example, a purchased electronic book is protected by digital rights management as accessed through an electronic book reader on a computing device.

In one exemplary aspect, the user is able to interact with the copy of the electronic document on the computer device and the electronic document file package containing that copy is configured to allow for one or more portions of the electronic document to be actively updated with content from the document server (e.g., a user may receive an electronic book from a document server and when the computing device is connected to a document server, which may be a different document server from the download document server, via the network, the content of the electronic book may be updated). The user may obtain the electronic document in a variety of ways (e.g., purchasing/receiving the electronic document via a purchase transaction from a service provider, purchasing/receiving the electronic document via a subscription relationship with a service provider). In one example, updated information delivered to the electronic document package becomes part of the copy of the electronic document itself (e.g., adding, subtracting, and/or replacing information in the copy of the electronic document). Exemplary implementations of an active electronic document system and/or method may include an ability to view real time data associated with the content of the copy of the electronic document, an ability to allow the user to perform one or more transactions associated with one or more portions of the content of the electronic document, an ability to allow a user of an electronic document to subscribe to one or more services in association with one or more portions of the content of the electronic document, an ability to provide a user of an electronic document one or more advertisements based on and/or associated with one or more portions (e.g., an active area) of the electronic document, an ability to share notes in association with the electronic document across copies of the electronic document and/or to third-party online services (e.g., a social networking service), an ability to link information from one or more portions of the electronic document to a user-defined display screen (e.g., a custom resource page), an ability to link information from one or more portions of the electronic document to one or more other electronic services, an ability to provide electronic services to publishers and other businesses for implementation across one or more copies of an electronic document in an active document system and/or method, and any combinations thereof.

A document server (such as the Active Book Server) may be implemented as software, hardware, and/or any combination thereof. It is contemplated that any one or more of the aspects and features of the systems and methods disclosed herein related to a document server may be implemented on one or more servers (e.g., a software, hardware, or combination server). In one example, a document server exists as a software implementation on a single server computer device. In another example, a document server exists as a software implementation distributed across multiple server computer devices. In one exemplary aspect, an electronic document is distributed to a user computing device by a first document server while update and other information is distributed to the user computing device to the electronic document by a second document server.

In one example, the electronic file package and/or the electronic document is protected by a rights management system. A rights management system may include mechanisms for protecting the contents of the document's electronic file package from unauthorized use or access to the document (e.g., copying, redistribution to others). For example, a rights management system may protect copyrighted materials from being copied from the electronic file package while allowing an authorized user the ability to view and interact with the copy of the document that is contained in the electronic file package on the user's computer. Other aspects and implementations of exemplary rights management systems are discussed further below.

Examples of an electronic document that may be included in an electronic file package include, but are not limited to, a book (e.g., a work of literature or other publication that traditionally purchased in a printed, bound edition), a trade or professional journal article, a commercial publication, a trade publication, a financial services publication, a magazine, a stock search report, a corporate publication (e.g., a privately published document, such as a research report or a manual), and any combinations thereof. An electronic document may include content information that is also available in a printed publication (e.g., a book). In another example, an electronic document includes information that is only available in an electronic form (e.g. industry analyst report by a financial services firm). An electronic document may be represented by a unique identifier (e.g., an alpha and/or numeric string used by an industry or publishing community to distinguish one publication from another). Examples of unique identifiers include, but are not limited to, an International Standard Book Number or ISBN, an International Standard Serial Number or ISSN, a publication serial number (e.g., a self-generated publication serial number, corporate identifier, and any combinations thereof. In one example, a unique identifier may serve as an identifier restricting access of distribution. In another exemplary aspect, an electronic document may be configured to display its content in multiple pages that are similar to the traditional pages of a book. For example, the content of the electronic document may be divided into electronic pages that are viewable to the user on a user interface one or more at a time (e.g., similar to turning the pages of a book). In one such example, the content of an electronic document includes content divided to electronic pages with the same or similar pagination as a printed copy of the document. In another such example, the content of an electronic document includes content divided to electronic pages with a different pagination as a printed copy of the document.

A user computing device may include an electronic document reader application (e.g., the Active Book Reader discussed below) that is configured to utilize machine executable instructions and/or hardware of the computing device to provide a user interface to one or more electronic documents (and optionally provide digital rights management). The electronic book reader application may be a dedicated application on a dedicated user computing device such as an ebook reader (e.g. typically reads standard ePub-type standard documents) or one of many applications on any computing device (e.g., a general purpose computing device, such as a tablet or laptop). The user computing device may include one or more memory elements for storing digital information related to a reader application, one or more document file packages, and/or additional digital data. A processing element of the computing device may access the data on the memory device and/or data provided over a network connection to a document server to display and/or provide interactivity with one or more electronic documents (e.g., using a reader application). A protocol of instructions for implementing one or more of the aspects and/or embodiments discussed herein may also be included, for example, on the user computing device, on the network, in the electronic file package, and/or to a document server.

As discussed above, an electronic document may be protected by a rights management system. A rights management system may be included as machine executable instructions (e.g., in combination with one or more hardware elements of a computing device) included as part of an electronic document file package, as part of a user interface (e.g., a reader application), as part of a separate system on a user computing device, as part of a document server, and any combinations thereof. In one example, a key system may be utilized to allow access to one or more aspects of an electronic document (e.g., to allow a user to view the document contents). Example keys include, but are not limited to an authorization key for an electronic document (e.g. a valid ISBN number), a purchase key from a document distributor (e.g. Apple iBook Store, Amaxon.com), a unique user key (e.g. credit card or computing device identification number), and any combinations thereof. In one example, use of a combination of one or more of an authorization key, a purchase key, and a unique user key allows a user to view the restricted (e.g., copyright protected) content while preventing the user from transferring the content to another user. In one example, an electronic document file package includes a rights management system embedded in the file package (e.g., such that the file package exists as a electronic document package including the copy/access protection therein) to ensure authorized access to the protected content.

A rights management system may provide a variety of levels of copy and/or access protection to an electronic document. Examples of levels of copy and/or access protection include, but are not limited to, preventing any copying of content from an electronic document, allowing copying of one or more predetermined portions of content from an electronic document, allowing copying of one or more user selected portions of content from an electronic document, allowing copying of a predetermined amount of content from an electronic document, allowing copying of one or more predetermined amounts of content from an electronic document for a corresponding financial payment, and any combinations thereof.

In one exemplary implementation, a user is able to upgrade an ebook based on industry standards, or variant of this standard, (e.g. ePub or electronic publication standard which is an open e-book standard by the International Digital Publishing Forum (IDPF)) to allow for one or more portions of the electronic document to be actively updated (now referred to as an Active Electronic Document) with content from an authorized document server (such as an Active Book Server) unique to the content of the copyright protected electronic document (e.g., when an Active Book Reader is connected to an Active Book Server via a network).

In certain examples, an Active Book Server can be logically tied to one Active Electronic Document. In such an example, it may be required that the Active Book Reader authorize and match the Active Document with that document's (or title or ISBN) unique Active Book Server. In addition, the Active Book Reader may validate that the user has purchased or is authorized to view the electronic document. In one example, updated information, from that document's Active Book Server, is delivered to the active electronic document and/or Active Book Reader where it becomes part of the copy of the electronic document itself (e.g., adding, subtracting, and/or replacing information in the copy of the electronic document) while maintaining the rights management of the industry standard ebook or variant. Once an ePub or static electronic document is registered with an Active Server and updated, that document becomes an Active Electronic Document. Exemplary implementations of an active electronic document system and/or method may include the ability for an author of a copyright protected document to update said document on the Active Book Server and have Active Book Readers update the copyright protected document upon the user activating the Active Reader and accessing the electronic document on their remote computing device (e.g. ebook reader application connected over a wireless network to the Active Book Server). An additional exemplary implementation is an ability to transform a passive or static ebook document into an active document that provides for the inclusion of real time data associated with the content of the copy of the electronic document, an ability to allow the user to perform one or more transactions associated with one or more portions of the content of the electronic document, an ability to allow a user of an electronic document to subscribe to one or more services in association with one or more portions of the content of the electronic document, an ability to provide a user of an electronic document one or more advertisements based on and/or associated with one or more portions (e.g., an active area) of the electronic document, an ability to share notes in association with the electronic document across copies of the electronic document and/or to third-party online services (e.g., a social networking service), an ability to link information from one or more portions of the electronic document to a user-defined display screen (e.g., a custom resource page), an ability to link information from one or more portions of the electronic document to one or more other electronic services, an ability to provide electronic services to publishers and other businesses for implementation across one or more copies of an electronic document in an active document system and/or method, to share authorized sections with social networks, and any combinations thereof.

In one exemplary implementation, an electronic document is provided to a user computing device from a document server via a network. Subsequently, one or more portions of the electronic document are identified for active interaction (e.g., updating, enhancement such as via additional information relevant to a portion of the document, supplementation, and/or other interaction according to the current disclosure). While connected to a document server (e.g., the same document server that provided the copy of the electronic document originally or a different server), the one or more portions are, for example, updated with information from the document server. In one exemplary aspect, this updating can be done without replacing the copy of the electronic file and/or its electronic document file package.

In another exemplary implementation, a method of updating a document includes connecting to a first remote document server via a network; downloading to a local device a copy of a document having content provided in a plurality of viewable pages; automatically receiving an update to a subset of the content of the copy from a second remote document server; updating the subset of the content without replacing the entire copy of the document; and viewing the plurality of viewable pages with the local device being disconnected from the network.

In yet another exemplary implementation, a method of modifying a document located on a user device (e.g. book reader or book reader application on a computing device such as a tablet or laptop) remote from a document server with updated information from the document server is provided that includes connecting the device having the electronic document file package to the document server via a network. One or more subsets of the information in the electronic document file package to be updated are identified and a set of updated information for the one or more subsets is provided from the document server via the network. The one or more subsets are updated with the updated information without replacing the entire electronic document file package.

In still another exemplary implementation, a method of providing access to an electronic document having a unique identification number assignment and being protected by a rights management system includes displaying the electronic document using a user access interface (e.g., a document reader application), the user access interface implementing the rights management system to limit access to the information in the electronic document; providing the user with an option of selecting a portion of the information in the electronic document for posting to an online social networking service; and posting via a network connection between the user access interface and the online social networking service a portion of the information in the electronic document to the online social networking service when selected by the user. In one example, the user selects a limited portion of the content of the document for posting without paying an additional fee. In another example, the user selects a limited portion of one size for posting without an additional fee and is presented with an option of selecting one or more additional portions of different corresponding sizes for an additional fee corresponding to the size of the portion selected for posting. In one such example, a rights management system is configured to manage the fee collection and allowance of copying to a social networking service.

In still yet another exemplary implementation, a method of sharing information related to an electronic document (e.g., an electronic document having a unique identification number assignment and/or being protected by a rights management system) includes displaying the electronic document using a user access interface, the user access interface implementing a rights management system to limit access to the information in the electronic document; allowing the user to enter a notation and to associate the notation to one or more portions of the information in the electronic document; providing the user with an option to post the notation and/or the one or more portions of the information to an online social networking service; and receiving from the user an instruction to share the notation and/or the one or more portions of the information to the online social networking service, a group of readers (e.g., defined by a user) of the same electronic document. In one example, in order to share one or more notes, the notes are transferred to other readers of the electronic document (e.g., an electronic book of the same ISBN number or title) based on those users owning rights to view that same document. In such an example, the document is not transferred with the notes.

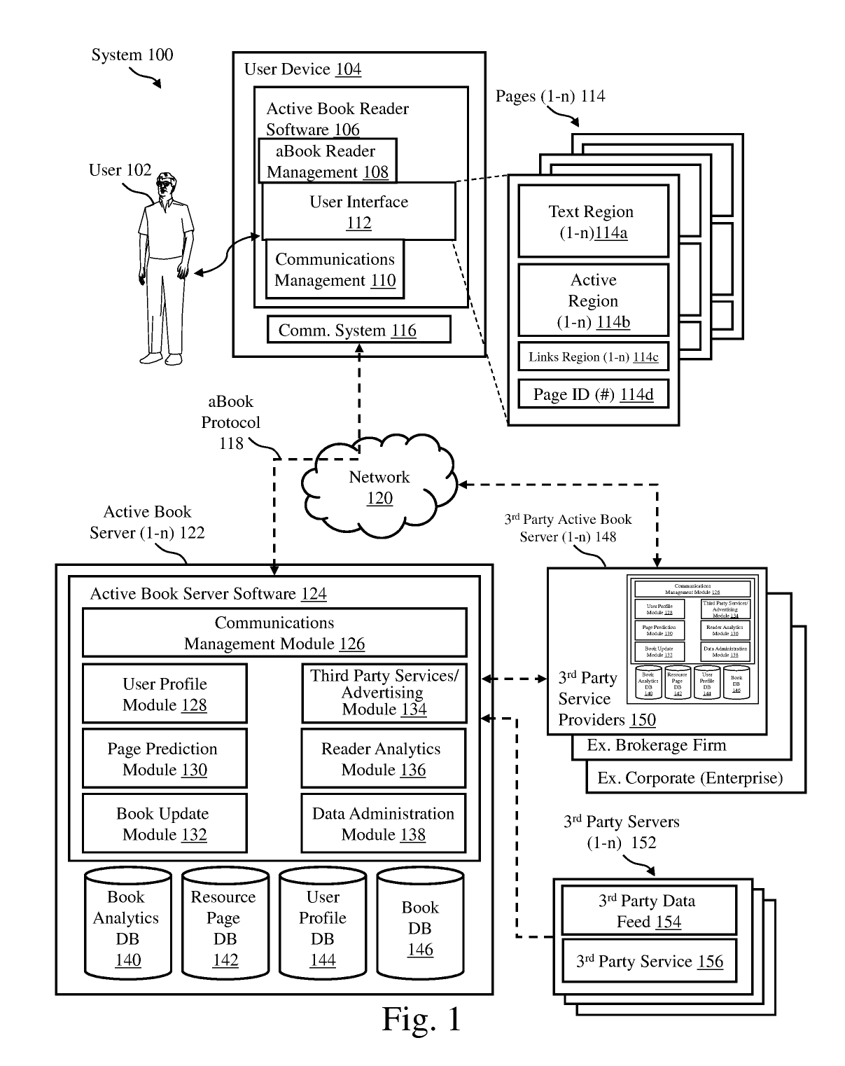

Various additional aspects and embodiments of the present disclosure are discussed below with respect to the examples of FIGS. 1 to 18 It is contemplated that any one or more of these additional aspects and/or embodiments may be combined in various combinations with one or more other exemplary implementations discussed above or below. These figures illustrate a system and methods for revising electronic book copyrighted content and supplementing electronic document content with real-time and subscription information services, as well as transaction services. Throughout the description below an electronic document according to the present disclosure and various aspects of the related functionality may be referred to an Active Book or an “aBook.” It is contemplated that the aspects and/or embodiments discussed below with respect to aBooks will apply to other forms of electronic documents (e.g., as discussed above). Example aBooks maintain book content and allow for automatically updating the electronic document content, unlike prior art electronic or printed books having static content. One exemplary system embodying the present disclosure is a system of four components: 1) an Active Book Document or aBook, 2) an Active Book Reader, 3) an Active Book Protocol, and 4) an Active Book Server. The reader is typically displayed on a computing device, for example a mobile computing device such as a tablet or laptop, and is connected through a protocol to the server to transmit and receive, for example, content updates, author-generated or tailored third-party information services and other examples of content-relevant transaction services.

Exemplary implementations relate generally to publicly and privately published electronic documents (e.g., electronic books and other similar electronic documents). For example, published documents include, but are not limited to, books, magazines, periodicals, corporate documents (such as research reports and manuals), other electronic services, and any combinations thereof. One example of an application of the present disclosure is to transform a traditional ebook's static content to provide a means for remotely and electronically altering the content. Examples of altering ebook content include: 1) revising copyrighted material; 2) regularly updating content (such as numbers, figures, charts, videos); 3) supplementing content by downloading real-time data (such as stock prices, (streaming) videos, live data feeds) for integration into the content; 4) sharing book content (such as book notes); and 5) offering subscription or transaction services such as the ability to view stocks within a stock research report and execute a stock or stock portfolio purchase as an integrated experience within the aBook's structured content. These examples only illustrate some of the uses of this particular application of the present disclosure.

Another example of altering ebook content includes permitting the content to be tailored to the tastes of the subscriber. Some examples of tailored content include: 1) providing subscribers with the most current information, independent of the issue date of the original book or other published data; 2) providing an ability to subscribe to tailored author or third party generated information services which integrate with the aBook's content; and/or 3) transaction services offered directly from the aBook.

A further example of an application of the disclosure is permitting the content supplier (e.g., publisher, corporate publisher, book distributor) to tailor the content of an electronic document. Some examples include, but are not limited to: 1) extending the relevancy of traditional books and published data 2) offering additional services (e.g., services that add value and generate revenue and 3) identification of reader market intelligence. In one exemplary aspect, identifying the reader may allow for more targeted marketing to enhance the reading experience, directing them to similar topics of interest. In one example, a reader can be guided to related topics they have accessed on a prior read. In another exemplary aspect, various active interactions with a copy of an electronic document as described herein may provide benefits to the economy generally, such as the opportunity to create new employment opportunities in an industry with declining employment and the opportunity to reduce the 78 billion printed pages per year which consume precious resources of trees, water and energy required to transport and produce books. In yet another exemplary aspect, there may be a significant productivity benefit for a student and/or worker reader as they may be able to learn, access and/or take action with respect to a copy of an electronic document utilizing current (e.g., updated) information.

In one embodiment, an electronic book-like user interface is provided on a computing device, which includes the viewing capability for one or more electronic documents that can be updated electronically (e.g., remotely, initiated by the user, initiated by a document server) and automatedly (e.g., an Active Book Protocol can be transmitted over a network such as the Internet and/or wireless networks). The aBook allow for updates within the structured book content that may include, for example, data services and revisions to book content including text, videos, charts, and links. Other examples will be apparent to those skilled in the art.

Current electronic publishing techniques for creating electronic books, magazines, journals, catalogs, textbooks, corporate documents, or other published text, simulate the appearance of traditional physical books, magazines, journals, textbooks, corporate books and reports, or other published text. Electronic alternatives to the printed equivalent are displayed on a computing device.

Existing electronic book and document publishing standards and publishing software provide for a static text and simple graphics, standard with traditional book-like user capabilities. The current electronic book represents a digital manifestation of a paper equivalent. Its configurable capabilities include: 1) definition of contents to be displayed in the electronic book at the time of electronic publishing, 2) the static content and formatting aspects, such as the book page layout and dimensions, and 3) the reading aspects, such as when a page is to be flipped. Utilizing common publishing software, the content and typeset of the printed version of a book is typically identical in form to its electronic equivalent, based on traditional desktop or typesetting publishing processes. Publishers have experimenting with banner and click-through advertising to websites much like current website services. However, content remains static or passive within the book, document or magazine.

Existing electronic publishing and on-line distribution methods lack the capability to remotely update book content, provide integrated multi-media presentations, provide supplemental, value-added services, or engage other readers while maneuvering through the book content. Like printed books, these types of traditional electronic books only allow for static or passive interaction with the reader. They do not provide up-to-date, current or real-time information, supplemental information or transaction services. As a result, books (particularly those with time-related material) have a shorter shelf life, as their content becomes less relevant with time. In addition, books, such as manuals (i.e. aircraft maintenance) need ongoing updates with supplemental video and data to keep them current. Existing electronic book/document approaches include directing readers to visit or search for websites to retrieve content updates for their electronic documents. Readers must then manually and outside of the electronic document itself associate these updates with the static content in a book in order to incorporate the most recent information.

Additionally, when the book content becomes obsolete or has new information, there are no current methods for authors or corporations to periodically electronically update the book. Authors work with publishers to create a revised edition of their book, typically every three years. Readers then purchase the latest version of the book in order to read new material. This is inefficient and costly for both the user and the publisher. It is ineffective to utilize out-of-date content in school textbooks, manuals, and financial services research reports, potentially significantly impacting the productivity of students, employees and readers.

In one exemplary aspect, an aBook may address an unmet need for a user-friendly, electronic book that provides automated and active updates of current-time information while reading the book content. In addition, electronic interaction with other readers may provide for sharing of notes and ideas.

Exemplary aBooks may provide significant benefits to document users and/or publishers in a variety of markets. Examples of users and industries that may benefit from one or more of the aspects or implementations of an aBook include, but are not limited to, financial services institutions, fund managers, investors, educators, students, educational institutions, government entities, publishing industry entities, retail catalogs, and any combinations thereof. Financial services institutions, fund managers, and investors value, for example, the most current research reports, stock reports, company publications, and industry publications. The delivery of the most timely information is an important factor to the decision-making process of fund managers and investors. Unfortunately, with current publishing standards, as soon as the research report is published, its value decays exponentially with time, due to the static content of these unchangeable, electronic reports. While there are many websites and data feeds offering real-time news and stock data, there is not a process for a researcher (author) to electronically update, in a secure manner, their copy protected research report once it is published. Nothing exists to provide readers with the most current financial data, insights and assessment to current events in context, in an integrated form within the contents of their research report.

In one exemplary aspect, an example aBooks may provide financial institutions the ability to extend the relevancy and improve their responsiveness to changing market conditions and events (government announcements or earnings announcements), specifically to the readers of these electronic-based research reports. Both the financial institution and the investor may be able to make more informed decisions by utilizing the most current information, which can be presented in a logical, structured and secure manner.

In educational institutions (e.g., schools and universities) the traditional textbook has been the common tool for students for many ages. However, electronic textbooks are becoming more popular. Electronic books have been used to provide an abundance of information and books to students, but they remain static and lack the ability to share the most up-to-date information.

In retail example, the traditional catalog can be replaced with an active catalog that allows the retailer to update the catalog and add value added services. In addition, the retailer can add videos corresponding to displaying product, “how-to” or instructional videos or other supplemental information to customers. This may save the retailer the need to have the user initiate the purchase or download a revised edition of a retailer's catalog.

In one exemplary aspect, an example aBook may allow students to have the most current version of the content issued by the publisher, and may allow them to share book notes from professors and fellow students. aBooks resolve this issue by providing students with up-to-date information. In another exemplary aspect, automatic updateability of a copy of an electronic document on a user computing device may allow professors to customize the content with lessons and case studies in a secure and copyprotected manner, without posting a brand new hard-copied book or wait to download a revised edition copy of a traditional electronic book. In yet another exemplary aspect, an exemplary aBook may utilizing live data, including streaming multi-media, to harness new collective thoughts, formulas, and additions to provide profitable learning to all students. Additionally, an example of an aBook may include an ability to students to share material. In still yet another exemplary aspect, an example updateable aBook may minimize the costs for educational programs to constantly bring in new books.

In government institutions, federal employees print millions of pages that are instantly discarded or recycled, costing the government an estimated $440.4 million each year. Publications and manuals currently created by the government could be placed in aBook format and be readily and routinely updated by the government allowing for cost-savings to the government and tax payers; as well as providing individuals the ability to have access to the most up-to-date government materials. Various exemplary applications of aBooks are horizontal in nature, and can apply to many branches of government, such as military, aircraft, and equipment manuals, tax policies and procedures, economic research reports, and intelligence reports.

There are constant changes in government documents which require creation of a newly revised book using a lengthy periodic process. In one exemplary aspect, an updateable aBook system may provide cost savings through the complete publishing supply chain process from conservation of paper, timeliness of information, lower cost distribution, more efficient authoring and creative process, and reduced costs from fraud and copyright piracy. Additionally, content such as videos, pictures, and other forms of media may be embedded and regularly updated in aBooks, consolidating materials into one source and providing potential overall cost savings, depending on the area of specialty with the government. One example is the updating of military maintenance or logistics manuals to incorporate the most current information and alerts.

In another exemplary aspect, companies in the publishing value chain may have an opportunity with exemplary aBook implementations to automatically integrate the capabilities they are currently offering, providing additional value to their customers. In yet another exemplary aspect, wireless service carriers may benefit from the use of example aBook implementations by increasing data traffic (e.g., due to updates) and possibly increasing revenues.

Exemplary implementations of aBooks may provide additional functionality. One or more aBook system and/or method implementations may include one or more of the following functionalities (i.e., discussed with respect to the examples numbered 1 to 9.

1. To Provide Downloading of Revised Content within an Active Book System.

In one exemplary aspect, an aBook system and/or method may provide readers of Active Electronic Books the ability to view revised content (e.g., copyprotected content, content not protected by a rights management regime) within the context of the existing electronic book that may be issued by the author, representative or third party into the Active Book on a regular, periodic and/or event-driven basis. Other types of entities may be authorized to issue content also. Active books may include structured content. Updating of an aBook or other electronic document according to the present disclosure may be initiated by a variety of events. Examples of initiation of an update of one or more portions of content include, but are not limited to, initiating an update at the time of connecting a user device having an electronic document in need of an update to a document server. In one example, an author and/or a publisher may provide structured and/or edited updates and/or revisions to an electronic document (e.g., a copy protected document. Such a revision process may insert new graphic charts or tables, videos, and/or other forms of multi-media as part of the revision process. In one example, the revised content may be merged seamlessly into the existing document without indication of revision. In another example, the revised content may be provided with an indicator of the revision (e.g., including an indication of the author of the revision). An archive of revisions and/or authors of revisions may be maintained (e.g., in the electronic document file package, in a reader application, and/or in an additional data repository associated with the system).

In another example, predictive download techniques described in greater detail below may provide users of usage sensitive networks (e.g., PCS 3G wireless) with potential decreased costs. In one such example, an aBook may be configured to download just the relevant data for the pages being viewed or about to be viewed.

2. To provide real-time data and updates an electronic book system.

Viewing stock prices is a real-time experience available on a variety of devices and platforms including websites and SmartPhones. Investors, investment firms, corporations, and news services are just a few of the segments across a broad audience most interested in the most recent stock prices. In the context of books, financial services research reports or corporate documents, the display of near real-time (current) stock prices and news alters are problematic. There is no ability to integrate stock prices within the context of structured book content or tables and charts within the book or research report. Second, the ability to activate the real time data to seek an expanded view of that data is problematic. In one example of an aBook implementation, a table of growth companies in a book may display fundamental financial data and real-time stock prices. The user could then choose to click on an associated stock ticker within that table to get an expanded view of stock history or real time intraday price movement.

An aspect of the present disclosure is the ability to view real time data associated with the published content. Examples of real time data include inserts within the published content, added or updated tables or added or updated graphic charts. In one example, an aBook may be configured to allow a user to activate graphic or expanded elements to view additional real time data associated with a data element. This feature may be applied to any type of content including, but not limited to, stock charts, financial data, economic data, scientific data, and other published content. Furthermore, this feature may be used by the content provider to analyze the user's preferences (e.g., statistical analysis of all reader's activations to provide market intelligence to the author regarding topics of reader interest). For example, a stock price may be inserted within the contents of the book. (see Figure P1). In order to provide these capabilities, the Active Book System may invoke software modules across the Active Book Reader and Active Book Server utilizing the Active Book Protocol. Prices are provided by a third party data feed. The user may invoke an expanded view of this data to view a stock chart.

3. To provide the ability to perform transactions (e.g., financial) services within an Active Book system.

Often times the purchasing of individual stocks is either an impulsive or emotional purchase of a result of in-depth backtesting and analysis. Missing from most investor's approaches is the construction of portfolios of stocks based on sound portfolio construction principles. Book and research authors often present portfolios or indexes in documents that are customized offerings for readers to purchase. As readers assimilate the context and characteristics of the portfolio, there is no integrated approach to take action to acquire this portfolio. The alternatives are to buy individual stocks at their local brokerage or contact a financial planner to manage this portfolio as their proxy.

In another exemplary implementation, an aBook may include the ability to initiate a transaction for services associated with one or more portions of the content in the book. For example, such initiation may occur from within the book content, including tables or graphic charts (that may represent the performance of an individual stock or a customized portfolio of stocks based on the content of the book). An aBook may also be configured to display an option to and to allow a user to activate a real-time update to information (such as stock performance information and/or customized portfolio information). followed by a transaction. Also, to be compliant with federal and state regulations, an aBook system and/or method may be configured to allow third party service providers the ability to present terms and conditions and forms for user approval integrated through a user interface of the Active Book.

Statistical analysis of all reader's activations to provide market intelligence to the author regarding topics of reader interest is also contemplated.

4. To provide subscription services within an Active Book system.

With the rapid migration of readers from printed to electronic books, margins are rapidly decreasing for publishers and authors. One of the major challenges as a result of digital transformation is the inability to offer new services to a static digital book. Derived from printed books which often sold through retail channels, electronic books which represent printed equivalents offer no subscription services upsell opportunity. As a result, the only option publishers have to increase revenue per reader is to sell more books!

In another exemplary implementation, a user of an Active electronic Book may have the ability to subscribe to services which are integrated or tailored for a book (e.g., the reader has the ability to subscribe to services which are offered within the context of the book) For example, an author-publisher arrangement may provide for free real-time stock prices for the first three months after book purchase (or other free introductory period). At that time, a user may have the option to pay a fee for an update subscription (e.g., updated price data). In addition, another fee-based subscriber service may be offered to provide customized stock research reports for the companies identified in the book. Subscription services may be data feed or information services. In one example, these services may be author, publisher or third-party generated. Services may be originated or resold where the author and/or publisher receive a commission or markup.

In another aspect, an indication to users may be provided that subscription services are offered in context of the sections of the book being read.

5. To provide advertising using an Active Book system.

Traditional web-based advertising techniques applied to electronic books are typically banner ads overlaid onto a static electronic book. Advertising revenues are based on click-throughs. In yet another exemplary aspect, an Active Book System and/or method may provide readers of Active electronic Books the ability to view advertising based on key words, logos or other symbols (e.g., which may be active regions located with the content of the book or corporate logos or key words located in the advertising area located on pages). Advertising may be relevant to the content of the page of the book. In one example, advertising is tailored to the content of each page so users experience the most relevant advertising. Advertising can be tailored for subscription services in addition to generic third party services. Advertising can be offered through customized search or RSS links located on the page.

In another exemplary aspect, the opportunity for advertisers to offer “try and buy” subscription services associated with the Active book may be provided

6. To share notes across electronic books using an Active Book system.

Capturing notes, listing websites to visit, listing stocks to watch and setting up alerts for news services relevant to the content of a book previously needed to be done across multiple platforms (e.g., websites, SmartPhones or Social Media sites such as Facebook and Twitter). Readers are expected to identify the appropriate search terms or RSS feeds most relevant to book content. After a book is read, readers rarely revisit that book as an ongoing resource, hence the competitive market for used books which is eroding new book sales for publishers.

In still another aspect, an aBook system and/or method may include an ability for Active Book readers to be presented with the opportunity to create a custom resource page that summarizes content and signals offered. This resource page could, for example, reside on a reader's electronic device and notify the reader of updates. Examples of services offered include, but are not limited to, stock and financial data updates, book updates, social media updates, tailored alert services, user groups (e.g., LinkedIn), news alerts, frequently asked questions, third party services updates and/or services.

In another exemplary aspect, an aBook may be configured to allow the communication of selected items from a resource page to be linked to a book associated Smartphone application. For example, a list of stocks on the move may be transferred to a SmartPhone application on a user's mobile phone. The features of the present disclosure described above may be combined with other electronic devices to facilitate updates, convenience of use, or for other reasons.

7. To share selective book or document excerpts on social media websites using an Active Book system.

Sharing excerpts from a prior art electronic book is protected by the copyright protection agreement for each book or copyright protected document. The digital rights management capabilities of an electronic reader in the prior art prevents a reader from copying even one word electronically. Readers are expected to translate the points made in the book with interested parties of an online system by manually typing into the online system. Aside from mentioning that the book is being read, there are few other links to social media.

With an aBook system, each book or document will have a set of copyright rules attached for the application to social media. A user may be provided the rights to copy a default number (e.g. 250 words) for free to a social media site (e.g. Facebook, LinkedIn, mySpace, Twitter). Thereafter, when the maximum number of words copied is exceeded the user may be offered the option to buy additional words to copy (e.g. 500 words for $1.00). The Active Book Server tracks word count copied and provides authorization to the Active Book Reader to enable word copy.

In still another aspect, the words copied onto a social media website may include a standard “signature line” (e.g. Excerpt from Book “ABC” by “Author”). This excerpt signature line may include a URL link directing a user to a location to buy the book, the publisher's website, the author's website or another website. The signature line and default link may be stored on the Active Book Server and be configured by an authorized representative (e.g. author, publisher, or other).

8. To provide resource pages using an Active Book system.

Capturing notes, listing websites to visit, listing stocks to watch and setting up alerts for news services relevant to the content of a book previously needed to be done across multiple platforms (e.g., websites, SmartPhones or Social Media sites such as Facebook and Twitter). Readers are expected to identify the appropriate search terms or RSS feeds most relevant to book content. After a book is read, readers rarely revisit that book as an ongoing resource, hence the competitive market for used books which is eroding new book sales for publishers.

In still another aspect, an aBook system and/or method may include an ability for Active Book readers to be presented with the opportunity to create a custom resource page that summarizes content and signals offered. This resource page could, for example, reside on a reader's electronic device and notify the reader of updates. Examples of services offered include, but are not limited to, stock and financial data updates, book updates, social media updates, tailored alert services, user groups (e.g., LinkedIn), news alerts, frequently asked questions, third party services updates and/or services.

In another exemplary aspect, an aBook may be configured to allow the communication of selected items from a resource page to be linked to a book associated Smartphone application. For example, a list of stocks on the move may be transferred to a SmartPhone application on a user's mobile phone. The features of the present disclosure described above may be combined with other electronic devices to facilitate updates, convenience of use, or for other reasons.

9. To provide business methods using an Active Book system.

With the rapid migration of readers from printed to electronic books, the publishing industry is searching to identify innovations to provide valued services to readers. The static content of electronic books is problematic as a platform for publishers as a platform for new services and revenue sharing business models. At a recent conference, the CEO of a major publishing company declared that the industry will face a high degree of uncertainty and experimentation before identifying what readers value and what they will pay for. Publishers and on-line book agency business models have yet to identify services business models to restore revenue and profit growth to the publishing industry.

In another exemplary aspect, example aBook implementations may include configurations supporting a services business model. In one such example, traditional and new partners may add value and can capture revenue growth and revenue sharing opportunities. Beyond the traditional royalty model between publishers and authors, each may utilize an aBook system and/or method to incentivize the revision of aBook content and provide new author services to secure an annuity revenue stream from readers versus a onetime payment and royalty. On-line Book Sellers can not only secure commissions from the sale of books but can secure commissions from the resale of services from Publishers, Authors, Third Parties, RIAs and Brokerages (as one industry example). In another exemplary aspect, an Active Book may provide a new channel to market for the financial services industry players, as one industry example. These new business models may enable financial institutions the opportunity to provide new services via Active Books and revenue share with Active Book Partners. Third Parties—advertisers, corporations, data providers, multi-media news providers and the like—will also find new sources of revenue from user and partner expenditures which can offer innovation in services and revenue sharing business models. In another example, this partnering approach to business models creates the opportunity for new combinations of partners, revenue sharing and services reselling across industries beyond the financial services example explained above.

In yet another exemplary aspect, a Reader Analytics Module of an Active Server Software may be utilized to understand reader behavior in order to develop new services offerings and revenue sharing business models.

Exemplary embodiments of the present disclosure are now described below with respect to the enclosed figures. These examples provide systems and methods for using an Active Book (“aBook”) with an Active Book Server, which enabling a user to update book content on a real time basis and engage the user with active links

The system and methods of the present disclosure are may be applied to a variety of uses, users, and contexts. In this case, the present disclosure is described with primary reference to the financial services industry. It will be apparent to those of skill in the art, however, that the system and method of the present invention may be advantageously used in many different industries. Alternative uses of the system are defined to allow for a variety of traditional and non-traditional methods.

As used herein, “book” means textual, graphical or multi-media information, such as but not limited to, any novels, encyclopedias, articles, magazines, newspapers, catalogues, periodicals, or manuals. Although the term “book” is used in these examples, it is contemplated that other electronic documents, as described above, may also be utilized.

FIG. 1 illustrates a functional block diagram for an Active book System 100 in accordance with the present disclosure.

The Active book System 100 includes an Active Book User (herein “User”) 102, a User Device 104, an Active Book Protocol 118 (herein “aBook Protocol”), one or more Active Book Servers (1-n) 122, one or more 3^{rd} party Active Book Servers (1-n) 148, and one or more 3^{rd} Party Servers (1-n) 152.

User Device 104 further includes Active Book Reader Software 106 and Communication System 116. Active Book Reader Software 106 further includes aBook Reader Management 108, Communications Management 110, and User Interface 112. User Interface 112 further includes a plurality of Pages (1-n) 114, each of which may have one or more Text Regions (1-n) 114a, one or more Active Regions (1-n) 114b, one or more Links Regions (1-n) 114c, and a Page ID 114d. Active Book System 100 further includes at least one Active Book Server (1-n) 122 and an Active Book Server Software 124. Active Book Server (1-n) 122 further includes a Communications Management Module 126, User Profile Module 128, Page Prediction Module 130, Book Update Module 132, Third Party Services/Advertising Module 134, Reader Analytics Module 136, and Data Administration Module 138. Additionally, Active Book Server (1-n) 122 further includes Book Analytics Database 140, Resource Page Database 142, User Profile Database 144, and Book Database 146.

Active Book System 100 further includes one or more 3rd Party Active Book Servers (1-n) 148. 3rd Party Active Book Servers (1-n) 148 are any commercial servers running Active Book Server Software 124. 3rd Party Active Book Servers (1-n) 148 may be operated by one or more 3rd Party Service Providers 150. In a preferred embodiment, 3rd Party Service Providers 150 may include financial services firms, publishers, news agencies, multimedia content providers, and the like.

Active book System 100 further includes one or more 3^{rd} Party Servers (1-n) 152. The one or more 3^{rd} Party Servers (1-n) 152 further include a 3^{rd} Party Data Feed 154 and 3^{rd} Party Services 156. An Active Book Protocol serves as the communications language or protocol between the Active Book Reader 106 hosted within the User device 104, Active Book Servers (1-n) 122, 3^{rd} party Active Book Servers (1-n) 148 and/or 3^{rd} Party Servers (1-n) 152 is provided via Network 120, which is a standard data network such as a local area network (LAN), wide area network (WAN), Wi-Fi network (802.11x), Cellular Network, or Internet. Other networks are discussed further below with respect to FIG. 18.

User 102 is any individual using the Active Book System 100. User device 104 is any standard computing device such as but not limited to a Smartphone, desktop computer, notebook computer, or electronic book tablet computer. Active Book Reader Software 106 is a software application or formatted document residing on User device 104. aBook Reader Management 108 is a software module of Active Book Reader Software 106 responsible for applying updates to Active Book Documents. Communications Management 110 is a software module of the Active Book Reader Software 106 which encodes and decodes aBook Protocol 118 data.

The User Interface 112 is a software module which allows User 102 to graphically interact with the Active Book Reader Software 106. The one or more Pages (1-n) 114 display the content of an Active Book within User Interface 112 of Active Book Reader Software 106. The one or more Text Regions (1-n) 114a are graphical elements which display traditional-type text, such as textual content and graphics content of an Active Book (equivalent to a traditional electronic book). The one or more Active Regions (1-n) 114b are active elements which display Active Content, such as but not limited to streaming multi-media, video content, graphs, charts, pictures, and/or live data feeds. The one or more Links Regions (1-n) 114c are active elements which contain advertising, customized hyperlinks and RSS Feeds to external data sources. The Page ID 114d is a unique identifier for the page of the one or more Pages (1-n) 114 being displayed by User Interface 112 of Active Book Reader Software 106.

In one embodiment, the supplemental content in the Links Region (1-n) 114c includes hyperlinks to keyword internet searches. In another embodiment, the supplemental content in the Links Region (1-n) 114c includes an RSS (Really Simple Syndication) Feed of relevant news stories. In yet another embodiment, the supplemental content in the Links Region (1-n) 114c includes advertising and a link to a Frequently Asked Questions page. In yet another embodiment, the Links Region (1-n) 144c may contain any other interactive content such as, but not limited, to online message boards or polls.

The Communications System 116 of User device 104 represents any communication hardware, such as, but not limited to, wireless LAN hardware, such as a Wi-Fi (802.11x) card; cellular network hardware such as an AirCard; wired LAN adaptor or Network Interface Controller; and the like.

The Network 120 is a standard data network such as, but not limited to, a local area network (LAN), wide area network (WAN), Wi-Fi network (802.11x), Cellular Network, or Internet. The network utilized will be a function of the device, the user location to network access and the user's subscription to network service.

The aBook Protocol 118 is a protocol for communicating Active Book signaling information and content between the Active Book Reader 106 within the User device 104 and an Active Book Server 122. Particularly, aBook Protocol 118 exchanges data such as, but not limited to, a particular bit-pattern format for transmitting packets of data between a User device 104 and an Active Book Server 122. The aBook Protocol 118 can exchange Copyright Keys for authentication and identification purposes, book metrics such as page release version and reader viewing statistics (i.e. page being viewed), priority of book data update, and multi-media content being uploaded or downloaded.

The Active Book Server Software 124 is a software application residing on the Active Book Servers (1-n) 122. The Communications Management Module 126 is a software component that may reside in the Active Book Server Software 124 which encodes and decodes aBook Protocol 118 data. The User Profile Module 128 is a software component of the Active Book Server Software 124 responsible for managing user profile information stored in the User Profile Database 144. The Third Party Services/Advertising Module 134 is a software component of the Active Book Server Software 124 responsible for managing third party data services and reformatting these services to fit with the content of the book and subscription services. This module may also include the ability to track the number of users utilizing subscription services in order to record payments or commissions due to third parties.

The Page Prediction Module 130 is a software component of the Active Book Server Software 124 responsible for using aBook Protocol 118 data and data from the Books Analytics Database 140 to predict the next pages to be viewed on User device 104 by User 102. The Page Prediction Module enables the scheduling of background downloading of content and services to pages in advance of a user viewing these pages. The Reader Analytics Module 136 is a software component of the Active Book Server Software 124 responsible for collecting usage statistics from received aBook Reader 108 data. The Book Update Module 132 is a software component of the Active Book Server Software 124 responsible for managing (revised) author content and applying updates to the textual content of an Active Book. The Data Administration Module 138 is a software component of the Active Book Server Software 124 responsible for providing administrative functions to an author or other content provider. Examples of administration functions include, but are not limited to, server administration (i.e. storage levels), administrative alerts, user statistics, scheduling updates, security services and administrating communications with third parties or other networked Active Book Servers.

The Book Analytics Database 140 is a database stored on an Active Book Server (1-n) 122 which contains data representing user behavior statistics. Particularly, the Book Analytics Database 140 contains data such as, for example but not limited to, how often each page of an Active Book is viewed; how long each page of an Active Book is viewed; the order in which pages of an Active Book are viewed; active regions accessed, subscription services utilized, characteristics of the user device, and any combinations thereof.

The Resource Page Database 142 is a database stored on an Active Book Server (1-n) 122 which contains data representing readers' notes that can be shared across a community of readers. In one example, users can store a directory of other users with whom they desire to share book notes with.

The User Profile Database 144 is a database stored on an Active Book Server (1-n) 122 which contains user profile data for one or more Users 102 of an Active Book. Particularly, the User Profile Database 144 contains user preferences. Examples of user preferences include, but not limited to, Device and Active Book Reader Keys/Identification Codes, device characteristics, network service subscriptions and data plans, privacy restrictions, third party services subscriptions, payment plans, and any combinations thereof.

The Book Database 146 is a database stored on an Active Book Server (1-n) 122 which contains data representing the active content of the book. Within the book is a detailed map of all active regions aligned to page numbers and word, graphic, multi-media and link areas that serves as a framework to revise and download content to. In one example, the Book Database maintains an archive of all revisions or additions to an Active Book. In another example, the Book Database is typically accessed only by the author or representative of the person(s) who authored the Active Book.

The one or more 3^{rd} Party Active Book Servers (1-n) 148 are any commercial servers run by 3^{rd} Party Service Providers 150 which are capable of directly interacting with User device 104 and may contain various modules such as but not limited to communications management modules, user profile modules, page prediction modules, book update modules, third party services/advertising modules, reader analytics modules, and/or data administration modules. Additionally, the one or more 3^{rd} Party Active Book Servers (1-n) 148 may also include various databases such as but not limited to book analytics databases, resource pages database, user profile databases, and/or book databases. Particularly, the one or more 3^{rd} party Active Book Servers (1-n) 148 are representative of any server containing Active Book Server Software 124 which may provide Active Book content to an Active Book Reader 106 on User device 104. 3^{rd} party Active Book Servers (1-n) 148 are, for example but not limited to, an online bookstore server operated by Amazon; a server operated by an Active Book publisher, such as McGraw-Hill or John Wiley & Sons, a server operated by an investment firm, such as Fidelity Investments or Goldman Sachs and the like.

The one or more 3^{rd} party servers (1-n) 152 are any commercial servers that do not run Active Book Server Software. Particularly, the 3^{rd} Party Servers (1-n) 152 represent additional sources of data feeds or services that may be incorporated into the plurality of Active Regions (1-n) 114b of an Active Book. The 3^{rd} Party Data Feed 154 represents any data source, such as but not limited to, an RSS (Really Simply Syndication) feed of relevant news headlines provided by Thomson Reuters; stock ticker information for a particular list of stocks provided by Bloomberg; fundamental financial data by Standard & Poor's; and the like. The 3^{rd} Party Service 156 represents any service provided by a 3^{rd} party vendor Examples of 3^{rd} party vendor services include, but are not limited to, the investment of a User's funds into a stock by a Brokerage Firm; stock research reports; similar services, and any combinations thereof. In other markets such as education, this could relate to Summary Notes of the book from a third party, Case Studies from Professors or Videos from similar class lectures.

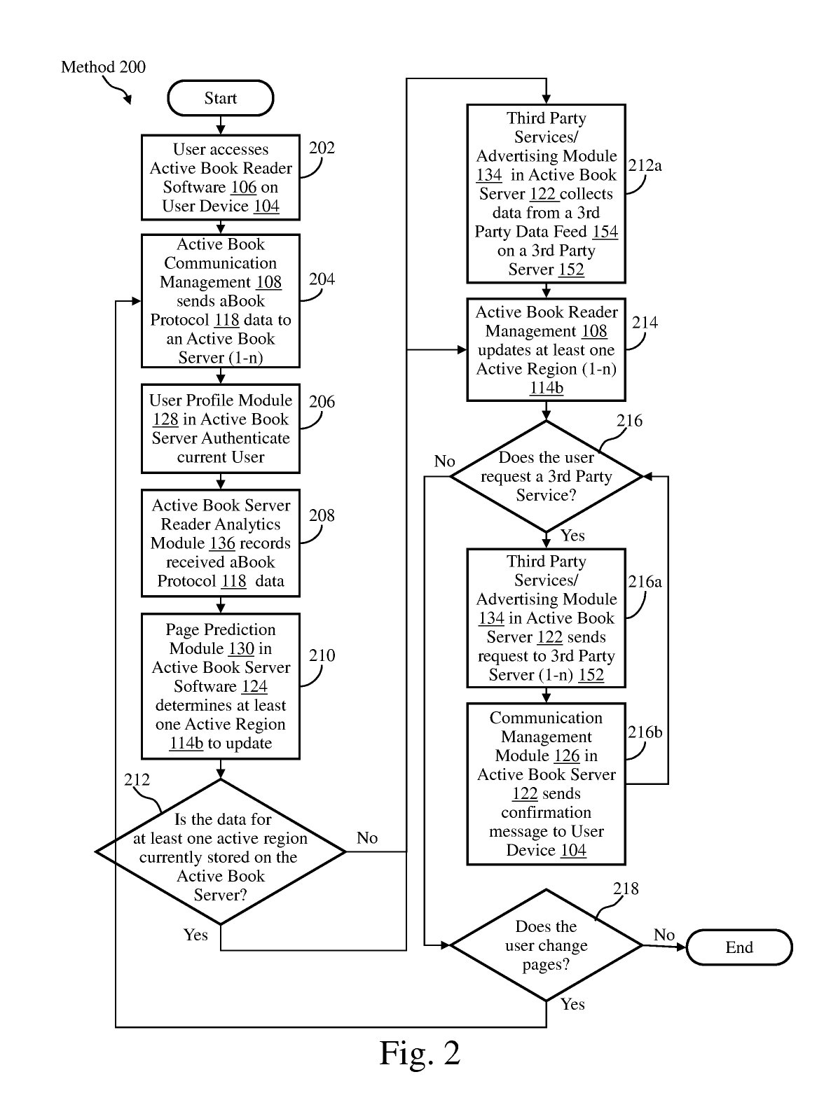

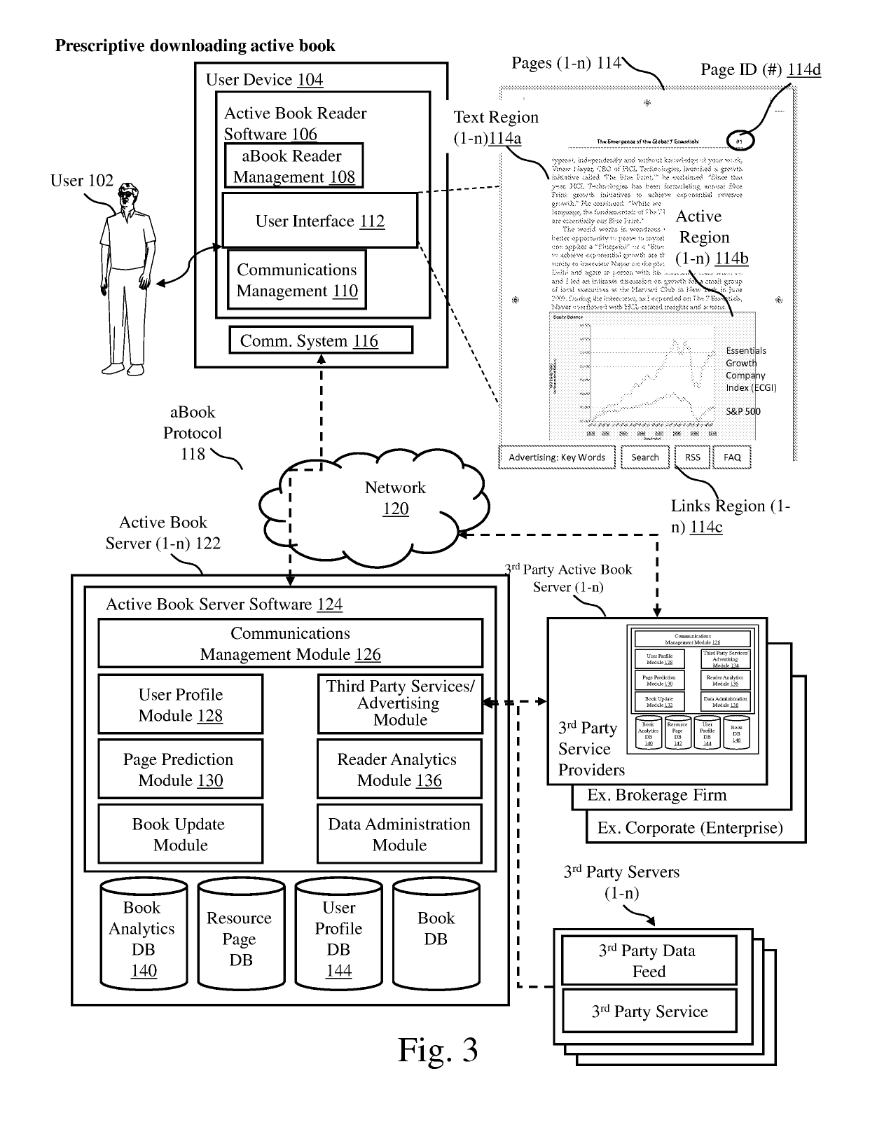

FIG. 2 illustrates a flow diagram for an exemplary method 200 for providing active content in an Active Book System 100.

### Step 202: User 102 Accesses Active Book Reader Software 106 on User Device 104

In this step, User 102 opens the Active Book Reader Software 106 on a User Device 104. The Active Book Reader Software 106 opens an Active Book file such as but not limited to, an Active Document Format (.ADF) file. In one example, the Active Book Reader may be configured to read active book file formats that incorporate active regions and links and passive file formats such as Adobe PDF and ePub so that users can read books of current and the new file format. The Active Book Reader Software 106 displays the content of the Active Book in the User Interface 112 on the User device 104. Method 200 proceeds to step 204.

Step 204: Communications Management 108 Sends aBook Protocol 118 Data to an Active Book Server (1-n) 122

In this step, Communication Management 108 in Active Book Reader Software 106 encodes aBook Protocol 118 data and sends the encoded data through the User device 104 via Communication System 116 over Network 120 to an Active Book Server (1-n) 122. The aBook Protocol 118 data includes information such as, but not limited to, User device 104 connection type (e.g., network information such as Wi-Fi, Cellular, LAN, etc); a specified version of the Active Book; the login information (Username, password, other credentials) for the User 102 of User device 104; the current page displayed in the User Interface 112; whether or not User 102 is subscribed to Active Region 114b updates; other similar information, and any combinations thereof. The Communications Management Module 126 of Active Book Server Software 124 decodes the aBook Protocol 118 data. Method 200 proceeds to step 206.

### Step 206: User Profile Module 128 in Active Book Server 122 Authenticates Current User 102

In this step, User Profile Module 128 in the Active Book Server 122 uses aBook Protocol 118 data decoded by the Communications Management Module 126 to authenticate User 102 and access user profile data in the User Profile Database 144. Method 200 proceeds to step 208.

Step 208: Reader Analytics Module 136 in Active Book Server 122 Records Received aBook Protocol 118 Data

In this step, Reader Analytics Module 136 in Active Book Server 122 records the data decoded by the Communications Management Module 126 in the Book Analytics Database 140. Particularly, the method records one or more of the data included in the aBook Protocol 118 data such as but not limited to the User device 104 connection type (Wi-Fi, Cellular, LAN, etc); the login information (Username, password, other credentials) for the User 102 of the User device 104; the current page displayed in the User Interface 112; whether or not the User 102 is subscribed to Active Region 114b updates; similar information; and any combinations thereof. Method 200 proceeds to step 210. In one example, the Active Book Server 122 records everything included in the aBook Protocol 118.

### Step 210: Page Prediction Module 130 in Active Book Server 122 Determines at Least One Active Region 114b to Update

In this step, Page Prediction Module 130 in the Active Book Server 122 uses data, such as but not limited to, the current page displayed in the User Interface 112 of the User device 104 and page history data from the Book Analytics Database 140 to determine the next most likely pages to be viewed by the User 102. The prediction algorithm is self-learning based on cumulative reader statistics. Additionally, the Page Prediction Module 130 determines how much of the electronic document (e.g., how many pages) to preload based on the type of connection the User device 104 is using to connect to the Network 120. Method 200 proceeds to step 212.

### Step 212: Is the Data for the at Least One Active Region Currently Stored on the Active Book Server?

In this step, if the data for the at least one Active Region 114b to be updated is not stored on the Active Book Server 122, the method 200 proceeds to step 212a. If the at least one Active Region 114b is stored on the Active Book Server 122, the Communications Management module 126 in Active Book Server Software 124 encodes the data for the at least one Active Region (1-n) 114b into the aBook Protocol 118 data format, and method 200 proceeds to step 214.

Step 212a: Third Party Services/Advertising Module 134 in the Active Book Server 122 Collects Data from a 3^{rd} Party Data Feed 154 on a 3^{rd} Party Server 152

In this step, Third Party Services/Advertising Module 134 in the Active Book Server Software 124 connects to at least one 3^{rd} Party Server (1-n) 152. The Third Party Services/Advertising Module 134 retrieves data for the at least one Active Region (1-n) 114b from a 3^{rd} Party Data Feed 154 on a 3^{rd} Party Server 152. The Active Book Server Software 124 then uses the Communications Management module 126 to encode the data for the at least one Active Region (1-n) 114b into the aBook Protocol 118 data format. The Communications Management module 114b then sends the aBook Protocol 118 data through the Network 120 to the User device 104. Method 200 proceeds to step 214.

Step 214: aBook Reader Management 108 Updates at Least One Active Region (1-n) 114b

In this step, Communications System 116 in the User device 104 receives the aBook Protocol 118 data from the Active Book Server 122. The Communications Management 110 in Active Book Reader Software 106 decodes the aBook Protocol 118 data from the Active Book Server. The aBook Reader Management 108 updates the at least one Active Region (1-n) 114b in the User Interface 112 using the decoded data from the Communications Management 110. Method 200 proceeds to step 216.

### Step 216: Does the User Request a 3^{rd} Party Service?

In this step, if the User 102 activates a link in the at least one Links Region 114c of the User Interface 112, the Communications Management 110 in Active Book Reader Software 106 generates an aBook Protocol 118 request for a 3^{rd} Party Service 156, and sends the request to an Active Book Server (1-n) 122. Method 200 then proceeds to step 216a. If the User 102 does not activate a link, method 200 proceeds to step 218.

Step 216a: Third Party Services/Advertising Module 134 in Active Book Server 122 Sends Request to 3^{rd} Party Server 152

In this step, Third Party Services/Advertising Module 134 in the Active Book Server 122 connects to a 3^{rd} Party Server 152 through the Network 120. The Third Party Services/Advertising Module 134 requests a service on behalf of User 102. Examples of such services include, but are not limited to, purchasing stocks through a brokerage firm such as Fidelity Investments; purchasing a managed account service or a research service; similar services; and any combinations thereof. After the 3^{rd} Party Service 156 has been completed on the 3^{rd} Party Server 152, the 3^{rd} Party Server 152 sends a confirmation message to the Third Party Services/Advertising Module 134 of the Active Book Server Software 124. Method 200 proceeds to step 216b.

Step 216b: Communication Management Module 126 in Active Book Server 122 Sends Confirmation Message to User Device 104

In this step, Communications Management module 126 in the Active Book Server Software 124 encodes an aBook Protocol 118 confirmation message, and sends the message to the Communications Management 110 in the Active Book Reader Software 106. The Communications Management 110 in Active Book Reader Software 106 decodes the aBook Protocol 118 confirmation message, and the User Interface 112 displays the confirmation message to the User 102. Method 200 proceeds to step 218.

### Step 218: Does the User 102 Change Pages?

In this step, if the User 102 changes pages, method 200 proceeds to step 202. If the user does not change pages, method 200 ends.

In another alternative embodiment, said system and method referenced above may be implemented in a cloud computing environment.

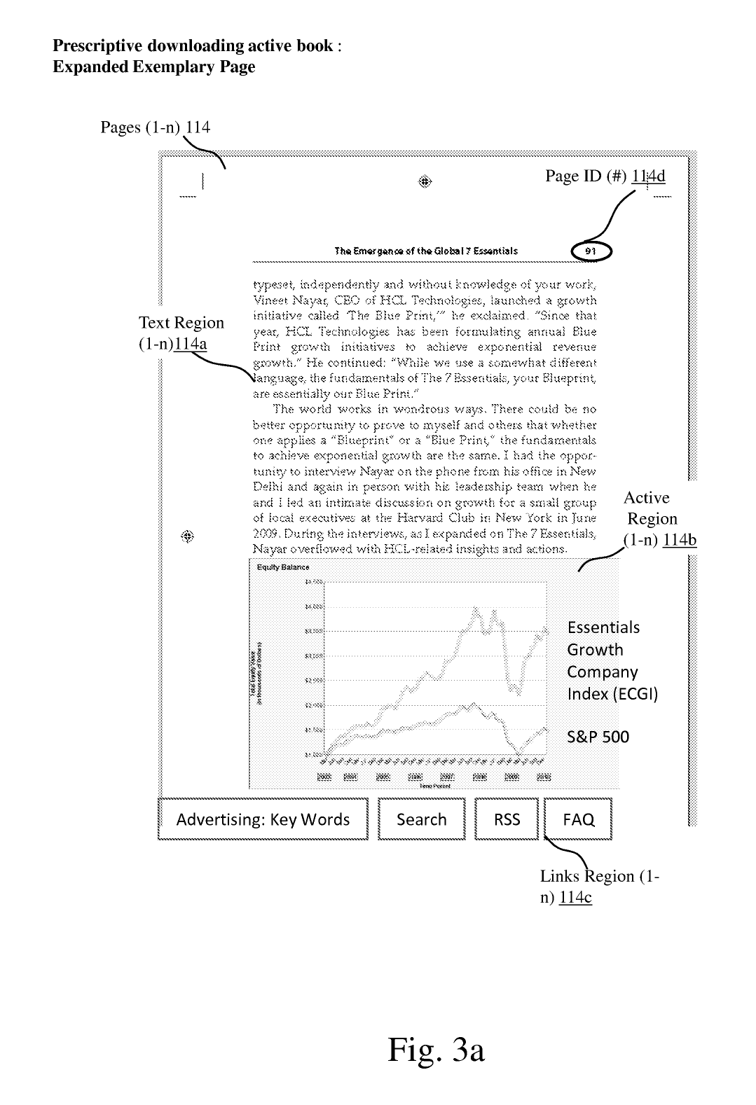

FIG. 3 illustrates a functional diagram for an example of prescriptive downloading active book content in an Active Book System 100.

### 1. Revised Book Content:

In this step, the User 102 has the option to open the book, change pages, or does not have to change pages.

A User 102 may open the Active Book Reader Software 106 on their User Device 104, for example a tablet computer, to display an Active Book with book content. The Active Book Reader Software 106 would proceed to display the initial page of the Active Book in User Interface 112, which may contain a Text Region 114a discussing for example, an Investment Strategy concept, an Active Region 114b containing revisable graphical or video content, for example a chart or graph of data illustrating the investment concept like a stock chart, and a Links Region 114c with links to additional relevant information or services, along with the Page ID Number 114d.

In an alternate embodiment, user interface 112 may contain a combination of one or more of these elements. The Communication Management 110 in Active Book Reader Software 106 may encode aBook Protocol 118 data containing information such as, but not limited to, the user of the book, a specified version of the Active Book a unique identifier for that User's 102 User Device 104, the connection type, what book is being viewed, the server operated by the publisher of the book, the current Page ID Number 114d, and a license key for Active Region 114b content updates, along with tags for any additional data needed to update the active region; or the aBook Protocol 118 data may contain a combination of one or more of these elements.

The aBook Protocol 118 data is then sent via the User Device's Communication System 116, for example a cellular Air-Card, over the Network 120, such as an internet-connected cellular network, to an Active Book Server 122 operated by the publisher of the book specified in the aBook Protocol 118 data. The publisher's Active Book Server 122 receives the aBook Protocol 118 Data, and decodes it using the Communications Management module 126 of the Active Book Server Software 124. The Active Book Server Software 124 would then authenticate the User 102 using the User Profile Module 128.

After authenticating the User 102, user profile data may be accessed in the User Profile Database 144, for example, to determine if a specified version (e.g., a more current revised edition) is available for download or to customize the settings of their active region 114b updates based on user settings. If so, the user will be presented with an update notification in process and notification where revisions to the book's contents were made.

The Reader Analytics Module 136 then records data from the aBook Protocol 118 data in the Book Analytics Database 140, such data may include but is not limited to the current page the User 102 is viewing and how long they have been viewing this page.

### 2. Predictive Content for Active Book Users Who are Reading the Book.

In one implementation, while readers are reading a book, the Communications Management 100 in the Active Book Reader 108 notifies the Active Book Server Software 124 the conditions to update the book-complete upload of all active regions or utilize the Page Prediction Module 130. The Page Prediction Module 130 uses data from the Book Analytics Database 140 to determine the next most likely pages the User 102 will view based on which pages were viewed next by other readers of the book. For example, pages 2, 3 and 10 respectively may be the next most highly viewed pages. Depending on the User's connection speed, the Page Prediction Module 130 will determine a number of pages 114 that the Active Regions 114b should be updated for, and prioritize each of these updates. If the user has a fast enough connection, the Page Prediction Module 130 sends the Active Region 114b updates for the current page, in this case page 1, and the next three pages likely to be viewed (pages 2 and 10) to the User Device 104 based on the priority of each Page. These updates would be prioritized so that data for the current page is updated immediately; for example, the current page 1 would be given the highest priority, while subsequent pages 2 and 10 would be given lesser priorities.

Afterwards, the Active Book Server Software 124 may proceed to aggregate the data for the Active Regions 114b to be updated on the current page (page 1) and next pages to be viewed (2 and 10). For the Active Region 114b on the current page 1, the data is available locally on the publisher's Active Book Server 122 in the Book Database 146, and so this data is converted to aBook Protocol 118 data in the Communications Management module 126, and sent over Network 120 to User Device 104. The Active Region 114b of the current page 1 would be updated in the User Interface 112 by the aBook Reader Management Module 108 of the Active Book Reader Software 106 on the User Device 104. Having loaded the current page, the user may view the Active Region 114b data in the User Interface 112 while additional pages are preloaded onto their User Device 104.

### 3. Supplemental Book Content for Subscriber Services.

Communications System 116 in the User device 104 receives the aBook Protocol 118 data from the Active Book Server 122. The Communications Management 110 in Active Book Reader Software 106 decodes the aBook Protocol 118 data from the Active Book Server. The aBook Reader Management 108 updates the at least one Active Region (1-n) 114b in the User Interface 112 using the decoded data from the Communications Management 110. This method is also utilized to update subscribed services with offer additional content to the book as inserts or appendices.

In one exemplary aspect, a system as described herein may 1) increase the shelf life of books by ensuring authors and publishers can distribute revised content in a more timely and lower cost manner, and/or 2) provide readers with the most current content from which to learn and make decisions. The latter is of particular value in financial services, education, corporate and government sectors.

Additionally, the revision of prior art electronic books mirror that of printed books—infrequent and not timely. Active Book revision updates may provide authors and publishers with a timely and low cost electronic method to update and revise copyright content.

FIG. 3a illustrates an expanded view of an example page of prescriptively downloading an active book.

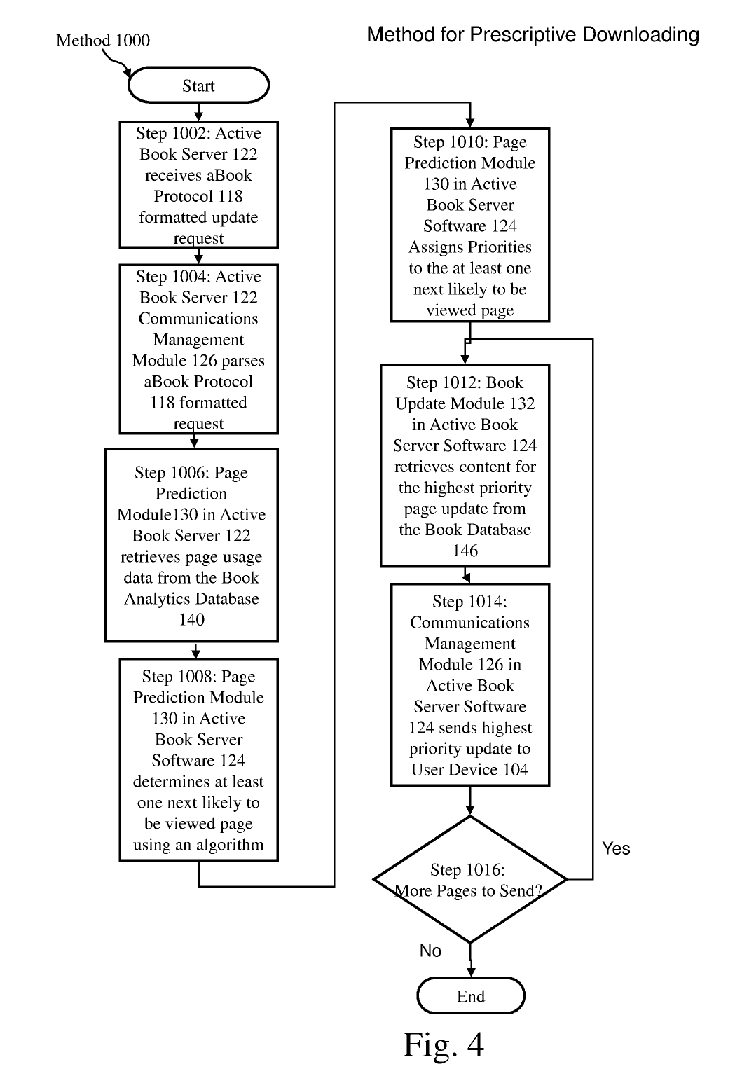

FIG. 4 illustrates a flow diagram for an example method 400 for prescriptive downloading active book content in an Active Book System 100.

### Step 402: Active Book Server 122 Receives Page Update Request

In this step, Active Book Server 122 receives a page update request from a User Device 104 over the Network 120. Active Book Server Software 124 using Communications Management Module 126 decodes the page update request based on the aBook Protocol 118, and authenticates the User 104 in the User Profile Module 128.

Step 404: Communications Management Module 126 in Active Book Server 122 Parses aBook Protocol 118 Formatted Request

In this step, Communications Management Module 126 in Active Book Server 122 parses aBook Protocol 118 formatted request.

Step 406: Active Book Server 122 Using Page Prediction Module 130 Retrieves Page Usage Data from the Book Analytics Database 140

In this step, Active Book Server 122 using Page Prediction Module 130 uses page update request data, such as but not limited to the current page being viewed by the User 102, and retrieves page usage data from the Book Analytics Database 140.

### Step 408: Active Book Server Software 124 Using Page Prediction Module 130 Determines at Least One Next Likely to be Viewed Page Using an Algorithm

In this step, Active Book Server Software 124 using Page Prediction Module 130 uses an algorithm to determine at least one next likely to be viewed page. In one example, the algorithm may use data such as but not limited to most common pages viewed prior to the current page and most common pages viewed next after the current page, to identify one or more likely pages to be viewed next.

### Step 410: Active Book Server Software 124 Using Page Prediction Module 130 Assigns Priorities to the at Least One Next Likely to be Viewed Page

In this step, Active Book Server Software 124 using Page Prediction Module 130 assigns priority values to the at least one next likely to be viewed page.

### Step 412: Active Book Server Software 124 Using Book Update Module 132 Retrieves Content for the Highest Priority Page Update of the 1 or More Pages (1-n) 114

In this step, Active Book Server Software 124 using Book Update Module 132 retrieves content for the highest priority page update of the 1 or more Pages (1-n) 114. In one example, the content for the page update is stored in the Book Database 146. In another example, the content for the page update may be stored on a 3^{rd} Party Server 152 and is accessed by the Third Party Services/Advertising Module 134. In yet another example, content for the page update may be stored on a combination of Book Database 146 and 3^{rd} Party Server.

### Step 414: Communications Management Module 126 in Active Book Server Software 124 Sends Highest Priority Update to User Device 104

In this step, Communications Management Module 126 in Active Book Server Software 124 encodes the highest priority page update based on the aBook Protocol 118 and sends the encoded page update to the User Device 104 through the Network 120.

### Step 416: More Pages to Send?

In this step, if there are more pages to send to the User Device 104, Method 400 proceeds to step 412. Otherwise, Method 400 ends.

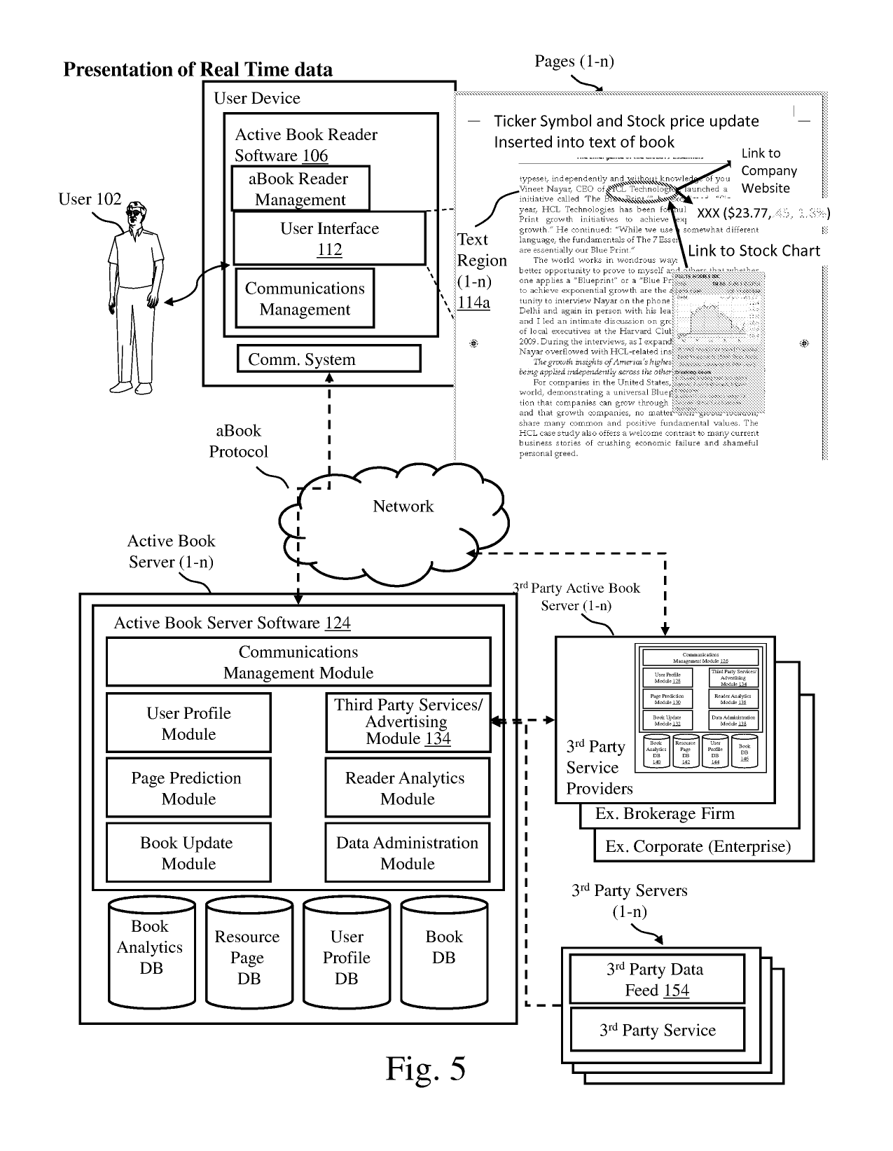

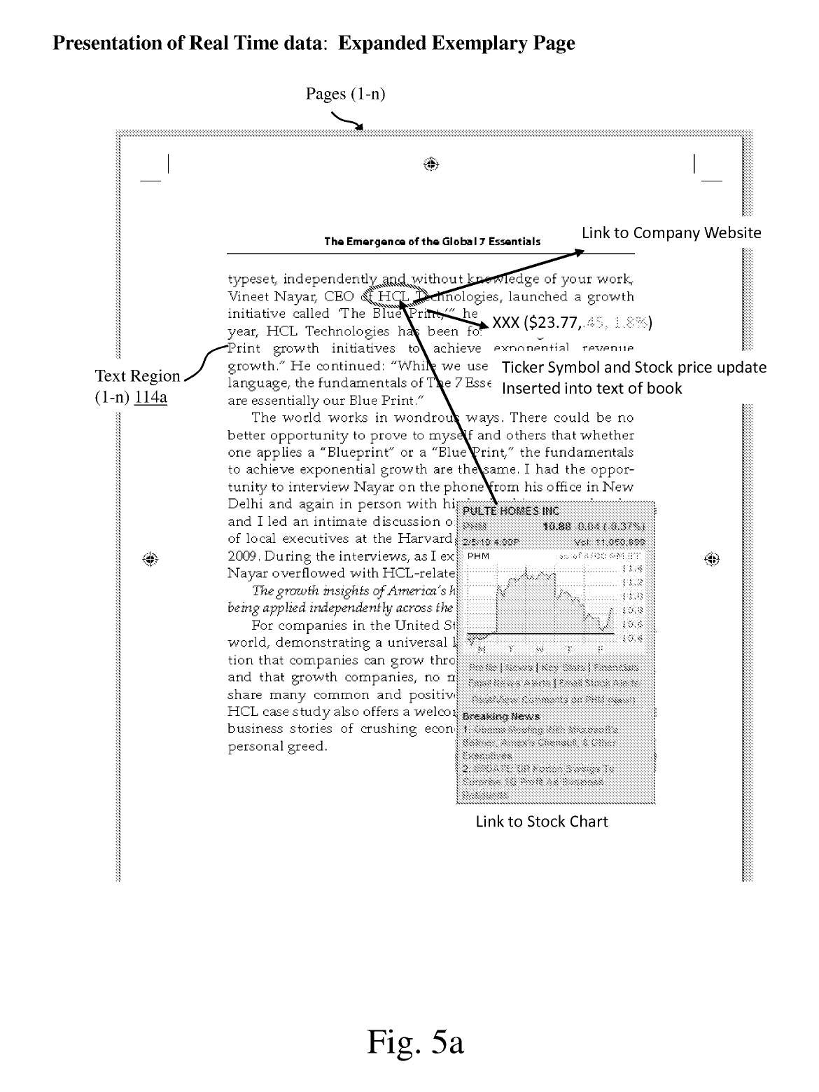

FIG. 5 illustrates a functional diagram for an example real time data downloading in an Active Book System 100.

Here, the Text Region (1-n) 114a may contain a stock ticker symbol for a company being discussed. For example, if the text was discussing ABC Technologies, the stock symbol for that company may appear with stock information next to it, as “ABC ($23.77, +0.45, +1.8%)” to show the current or real time price, amount change, and percent change of the stock. The ticker may be linked to current or real time data provided by an Active Book Server 124 which secures its price data from the Third Party Services/Advertising Module 134 and the 3rd Party Data Feed 154. Based on the current status of the stock being up 1.8% at that time that day, the User 102 chooses to see more information on the company by clicking on the symbol which is linked to a chart for that stock and recent news or press releases consistent in format with the book structure and content. The stock chart may have tailored metrics consistent with those discussed in the book's content. In one example, this additional information is displayed as a pop-up window or dialog box within the User Interface 112 of the Active Book Reader Software 106. In addition, stock prices may be embedded in table exhibits within the book and offer similar capabilities to those discussed above.

In one exemplary aspect, a system and/or method as described herein may 1) increase the effectiveness of readers to learn more about the companies discussed in the book, 2) provide opportunities for readers to leverage both the content of the book and incorporate real-time data into their decision making, and/or 3) optionally use this information to subscribe to alerts.

Additionally, electronic note taking in Active Books may offer readers a friendly and productive user interface to capture insights and ideas, the ability to simultaneously share those notes associated with content in the book with associates.

FIG. 5a illustrates an expanded view of an example page of real-time downloading an active book.

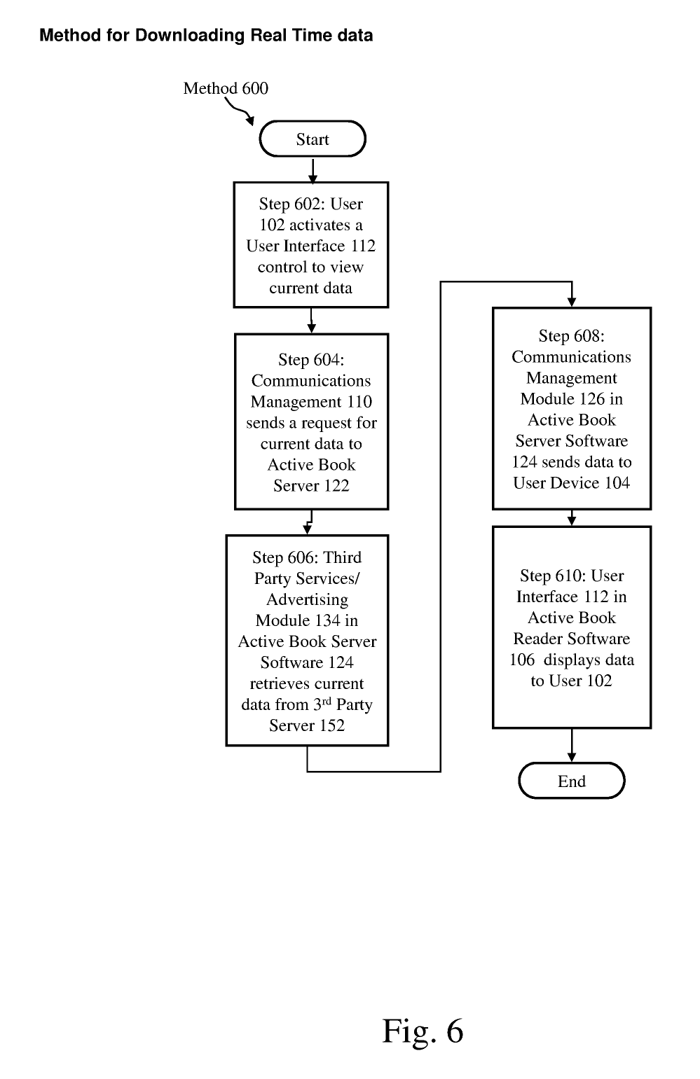

FIG. 6 illustrates a flow diagram for an exemplary method 600 for downloading real time data in an Active Book System 100.

### Step 602: User 102 Activates a User Interface 112 Control to View Current Data

In this step, User 102 activates a User Interface 112 control, such as a button, link, or menu item, to view additional data. In one example, said user interface control is embedded in the content of the current page of the Active Book. In another example, said current data may include current or real-time data such as, for example, stock quote information in text or multimedia form. Yet another example includes a combination of these elements.

### Step 604: Communications Management 110 Sends a Request for Current Data to Active Book Server 122

In this step, Communication Management 110 in Active Book Reader Software 106 encodes a request for data based on the aBook Protocol 118, and sends the encoded request to the Active Book Server 122 over the Network 120.

Step 606: Third Party Services/Advertising Module 134 in Active Book Server Software 124 Retrieves Current Data from 3rd Party Server 152

In this step, Communications Management Module 126 in Active Book Server Software 124 decodes the request based on the aBook Protocol 118. Third Party Services/Advertising Module 134 connects to a 3^{rd} Party Server 152 to retrieve the requested current data.

### Step 608: Communications Management Module 126 in Active Book Server Software 124 Sends Data to User Device 104

In this step, Communications Management Module 126 in Active Book Server Software 124 encodes the current data based on the aBook Protocol 118 and sends the encoded current data to the User Device 104 over the Network 120.

### Step 610: User Interface 112 in Active Book Reader Software 106 Displays Data to User 104

In this step, Communication Management 110 in Active Book Reader Software 106 decodes the current data based on the aBook Protocol 118. User Interface 112 then renders the current data to the user. In one example, the data is rendered to the user in the form of a pop-up box. Method 600 ends.

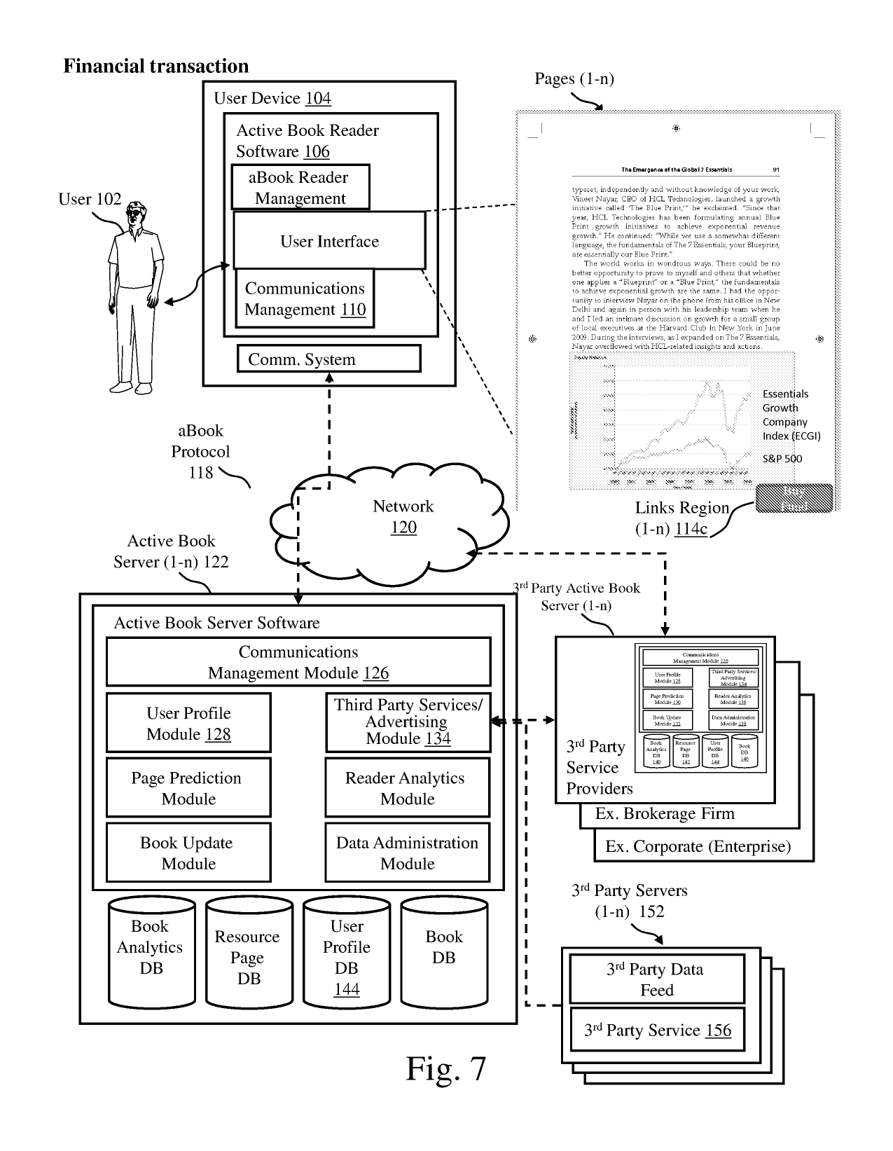

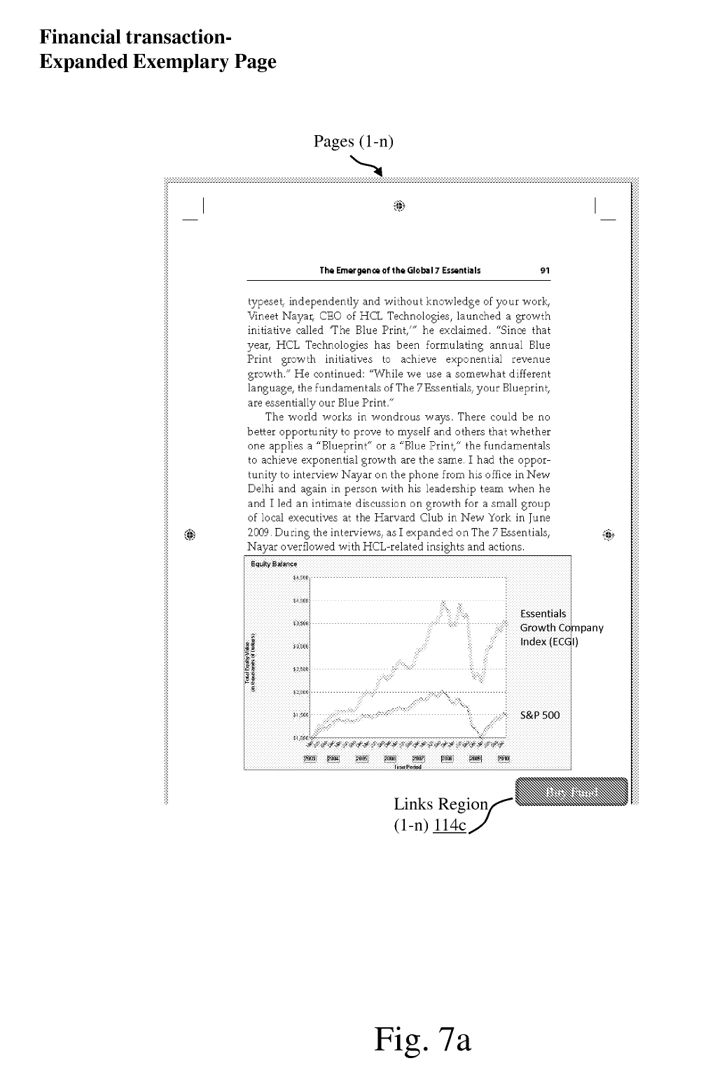

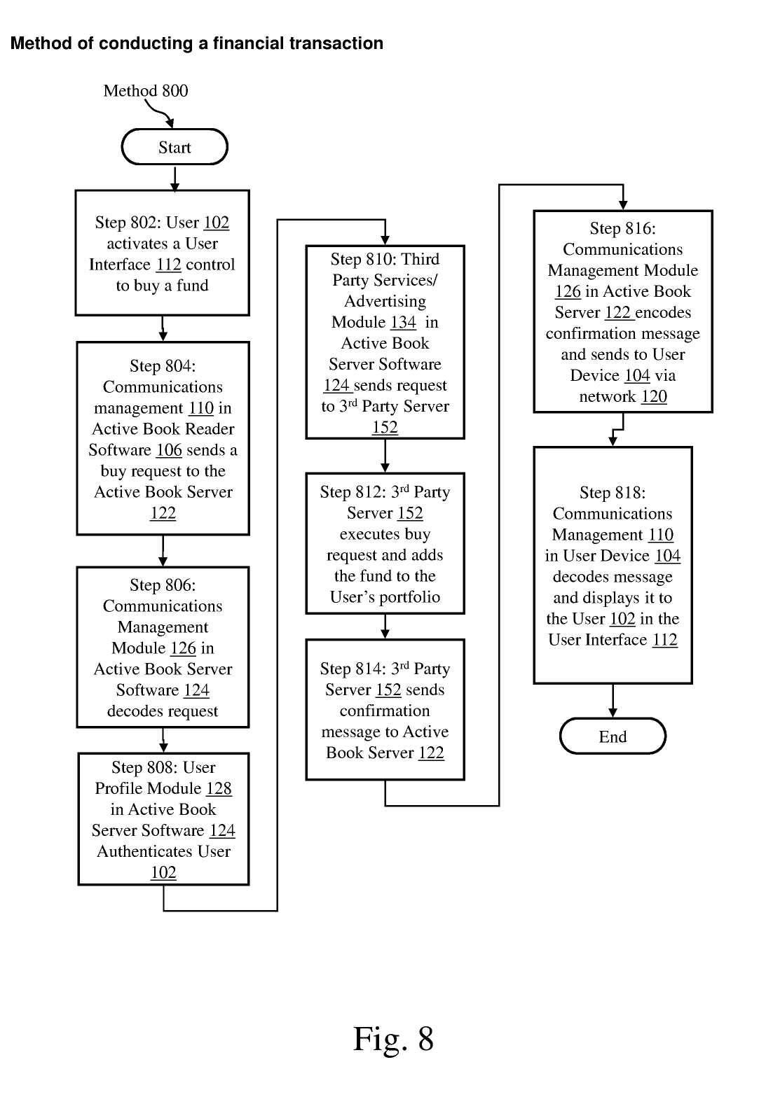

FIG. 7 illustrates a functional diagram for an example of financial transactions in an Active Book System 100.

Based on stock information, the User 102 may decide to purchase a stock through their brokerage service. The User 102 activates a link to purchase ABC Technologies stock through the User's 102 Brokerage service in the Links Region 114c of the current page (page 2), and identifies how much of the stock they would like to purchase. The Active Book Reader Software 106 generates a request to purchase this stock, and encodes it based on the aBook Protocol 118 in the Communications Management 110. This request is then sent through the Network 120 to, for example the Publisher's, Active Book Server 122. The Communication Management Module 126 in Active Book Server Software 124 decodes the request, authenticates the User 102 in the User Profile Module 128, and identifies the User's Brokerage Service such as STK Investments from information stored in the User Profile Database 144.

The Active Book Server Software 124 then uses the Third Party Services/Advertising Module 134 to submit the request on behalf of the user to a 3^{rd} Party Server (1-n) 152 operated by STK Investments to perform a 3^{rd} Party Service 156, in this case executing a trade using the API or RIA service provider for STK Investments trading platform. The User 102 is authenticated to STD Investments 3^{rd} Party Server 156 through a process such as, for example, federated authentication that validates the identity of the user, the device, the book, and a digital signature for the transaction. Fidelity Investments purchases the desired amount of stock for the User 102, adds the holding to the User's portfolio, and sends a confirmation message to the Active Book Server 122.

The Active Book Server 122 in turn encodes the confirmation message based on the aBook Protocol 118 in the Communications Management Module 126 and sends the message over the Network 120 to the User Device 104, where the confirmation message is decoded by the Active Book Reader 104 Communications Management 110 and displayed to the User 102 in the User Interface 112.

In one exemplary aspect, a system and/or method as described herein may 1) increase the effectiveness of readers to take more informed action to utilize services consistent with the content of the book or research report, and/or 2) provide seamless interfaces to service providers to minimize transaction errors.

4. Provide the Ability to Perform Transactions within an Active Book System

FIG. 7a illustrates an expanded view of an example page of a financial transaction in an active book.

FIG. 8 illustrates a flow diagram for an exemplary method 800 for conducting financial transactions in an Active Book System 100.

### Step 802: User 102 Activates a User Interface 112 Control to Buy a Fund

In this step, User 102 activates a User Interface 112 control, such as but not limited to a button, menu item, or link, to buy a particular fund through User's brokerage firm.

### Step 804: Communication Management 110 in Active Book Reader Software 106 Sends a Buy Request to the Active Book Server 122

In this step, Communications management 110 in Active Book Reader Software 106 sends a buy fund request encoded based on the aBook Protocol 118 to the Active Book Server 122 over the Network 120. This buy request may include information such as but not limited to the user, an identifier for the user device, the user's brokerage service, the amount of the fund to be purchased, similar information, and any combinations thereof.

### Step 806: Communications Management Module 126 in Active Book Server Software 124 Decodes Request

In this step, the Communications Management Module 126 in Active Book Server Software 124 decodes the buy request based on the aBook Protocol 118.

### Step 808: User Profile Module 128 in Active Book Server Software 124 Authenticates User 102

In this step, User Profile Module 128 in Active Book Server Software 124 authenticates the User 102. After authenticating the user, the User Profile Module 128 may retrieve information from the User Profile Database 144 such as but not limited to the User's brokerage service.

### Step 810: Third Party Services/Advertising Module 134 in Active Book Server Software 124 Sends Request to 3rd Party Server

In this step, Third Party Services/Advertising Module 134 in Active Book Server Software 124 connects to a 3^{rd} Party Server 152 operated by the User's brokerage service. The User 102 is authenticated to the 3^{rd} Party Server via, for example, Federated Authentication. The Third Party Services/Advertising Module 134 then submits the buy request to the Brokerage service through, for example, the API for the brokerage service's trading platform.

### Step 812: 3rd Party Server Executes Buy Request and Adds the Fund to the User's Portfolio

In this step, the 3^{rd} Party Server 152 operated by the brokerage service executes the trade on behalf of the user 102. The 3rd Party Server 152 operated by the brokerage service then adds the holding to the User's portfolio.

### Step 814: 3rd Party Server Sends Confirmation Message to Active Book Server 122

In this step, the 3^{rd} Party Server operated by the brokerage firm sends a confirmation message to the Active Book Server 122.

Step 816: Communications Management Module 126 in Active Book Server 124 Sends Confirmation Message to User Device 104

In this step, Communications Management Module 126 in the Active Book Server 122 encodes the confirmation message based on the aBook Protocol 118 and sends the confirmation message to the User device 104 over the Network 120.

Step 818: User Device 104 Using Active Book Reader Software 106 Displays Confirmation Message to the User 102

In this step, Communication Management 110 using Active Book Reader Software 106 decodes the confirmation message based on the aBook Protocol 118 and displays the message to the user in the User Interface 112 via, for example, a pop-up dialog box. Method 800 ends.

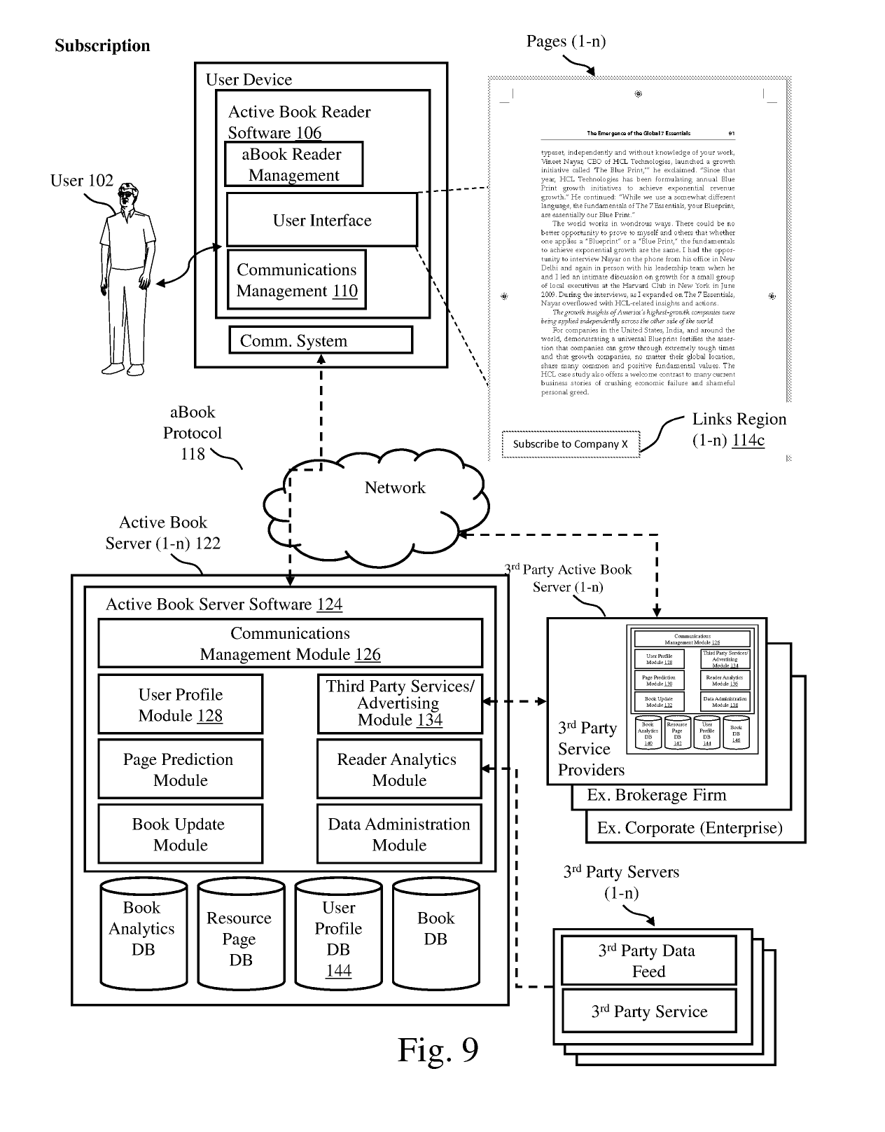

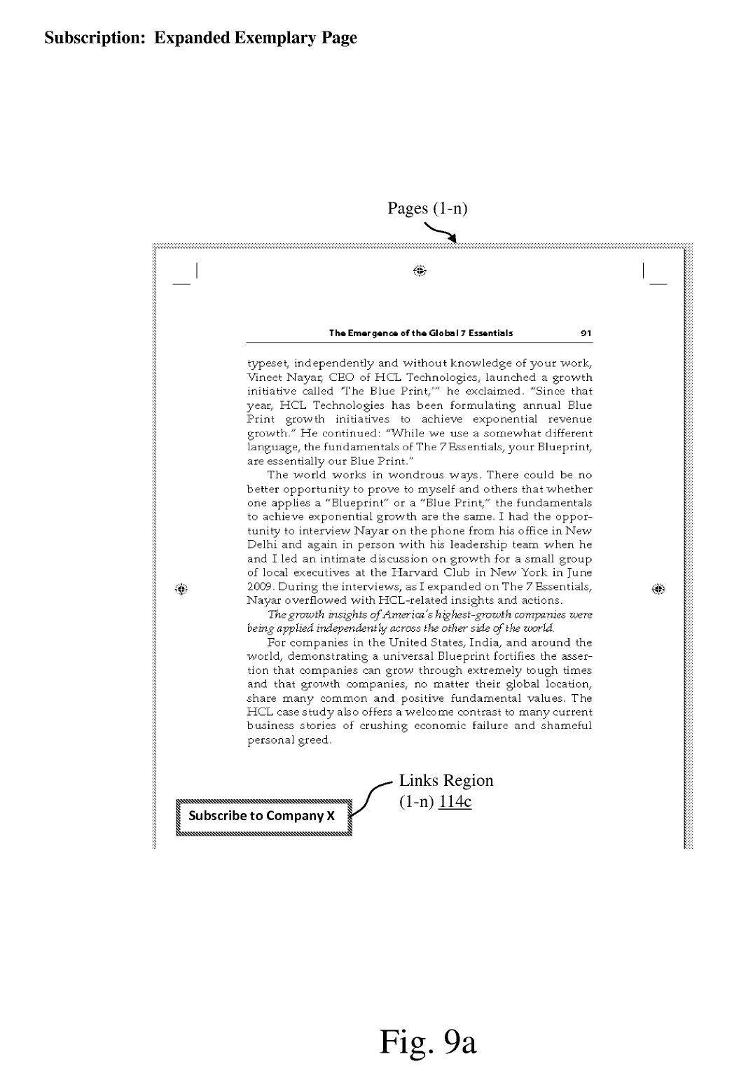

FIG. 9 illustrates a functional diagram for an exemplary subscription service in an Active Book System 100.

The User 102 decides to active a subscription service through an icon presented in the Links Region 114c. The Active Book Reader Software 106 notifies the Communications Management 110 to signal The Active Book Server Software 124 which is a software application residing on the Active Book Servers (1-n) 122. The Communications Management Module 126 is a software component of the Active Book Server Software 124 which encodes and decodes aBook Protocol 118 data. The User Profile Module 128 is a software component of the Active Book Server Software 124 responsible for managing user profile information stored in the User Profile Database 144. The Third Party Services/Advertising Module 134 is a software component of the Active Book Server Software 124 responsible for managing third party data services and reformatting these services to fit with the content of the book and subscription services. This module will also track the number of users utilizing subscription services in order to record payments or commissions due to third parties.

In one exemplary aspect, a system and/or method as described herein may 1) increase the shelf life of books by ensuring authors and publishers can distribute revised content in a more timely and lower cost manner, 2) provide readers with subscription services that complement the content of the book, and/or 3) provide upsell revenue opportunities for the author, publisher and other members of the book and services value chain.

Additionally, transforming an electronic book from a passive document that is being commoditized to a services model increases relevancy to readers and provides for increased revenue and margin to publishers and distributors of books. Active Book subscription services also provides Active Books as a new channel to market for service providers who desire to address the younger, tech savvy and content oriented market.

5. To Provide Subscription Services within an Active Book System

FIG. 9a illustrates an expanded view of an example page of a subscription service in an active book.

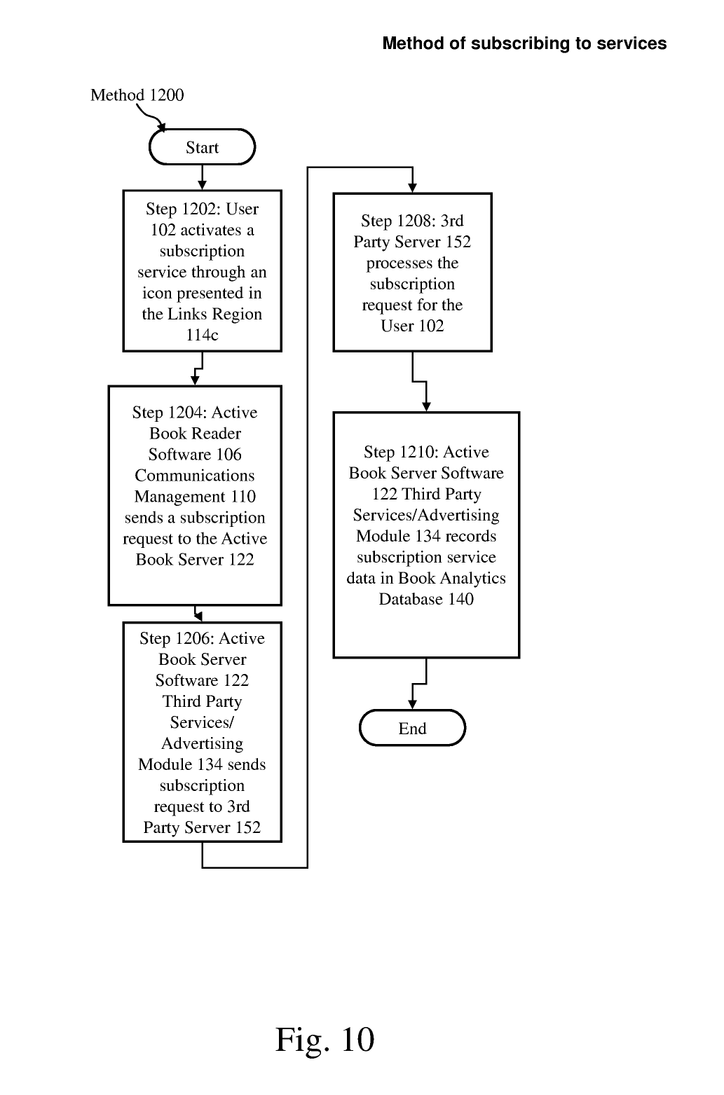

FIG. 10 illustrates a flow diagram for an exemplary method 1000 for creating a subscription service in an Active Book System 100.

### Step 1002: User 102 Activates a Subscription Service Through an Icon Presented in the Links Region 114c

In this step, User 102 activates a User Interface 112 Control, such as a button, link, or menu item in the Links Region 114c to request a subscription service.

### Step 1004: Active Book Reader Software 106 Communications Management 110 Sends a Subscription Request to the Active Book Server 122

In this step, Active Book Reader Software 106 Communications Management 110 encodes a subscription request using the aBook Protocol 118 and sends the request to an Active Book Server 122 over the Network 120.

### Step 1006: Active Book Server Software 122 Third Party Services/Advertising Module 134 Sends Subscription Request to 3rd Party Server 152

In this step, Active Book Server Software 122 Communication Management Module 124 decodes the subscription service request. Active Book Server Software 122 Third Party Services/Advertising Module 134 sends the subscription service request to a 3^{rd} Party Server 152 over the Network 120.

### Step 1008: 3rd Party Server 152 Processes the Subscription Request for the User 102

In this step, 3^{rd} Party Server 152 processes the subscription request for the User 102, and returns a confirmation message to the Active Book Server 122.

### Step 1010: Active Book Server Software 122 Third Party Services/Advertising Module 134 Records Subscription Service Data in Book Analytics Database 140

In this step, Active Book Server Software 122 Third Party Services/Advertising Module 134 records the subscription service data in the Book Analytics Database 140. In one example, subscription service data stored in the Book Analytics Database 140 may be used to track the number of users utilizing subscription services in order to record payments or commissions due to third parties. Method 1000 ends.

6. To Provide Advertising within an Active Book System

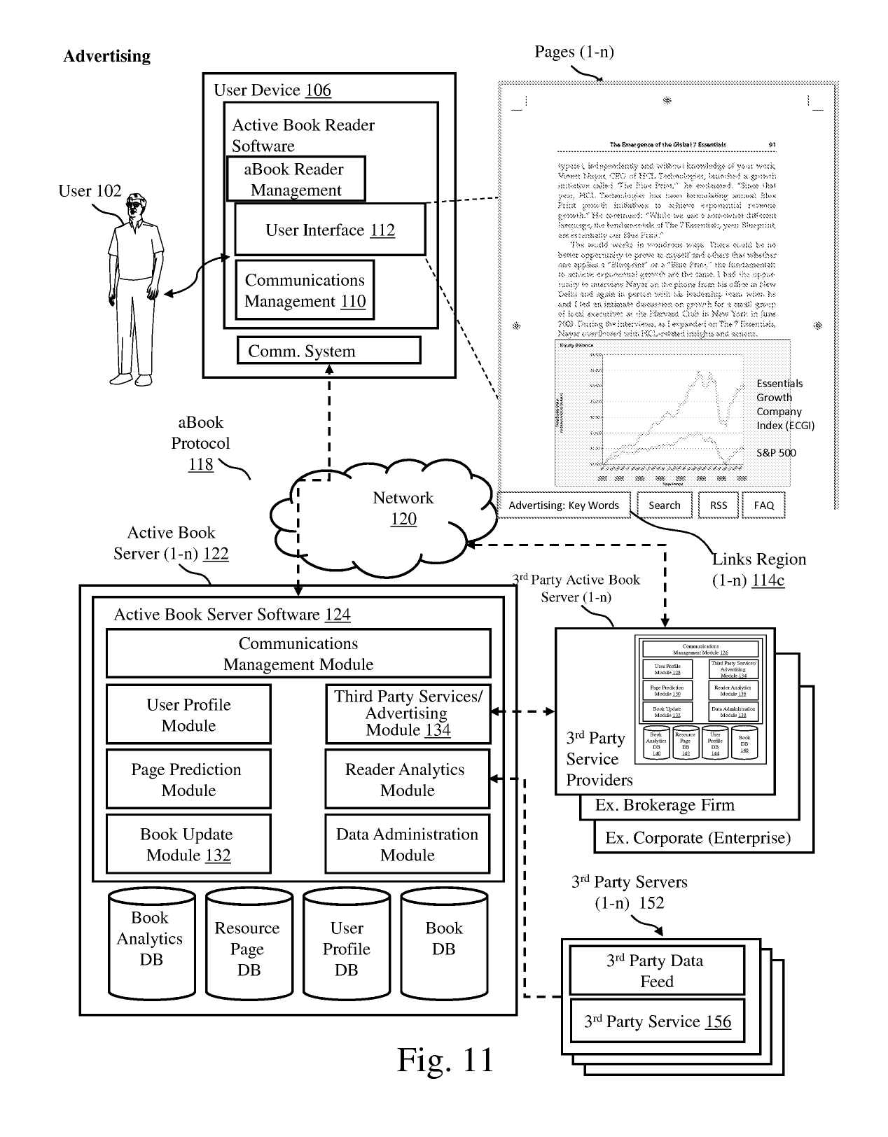

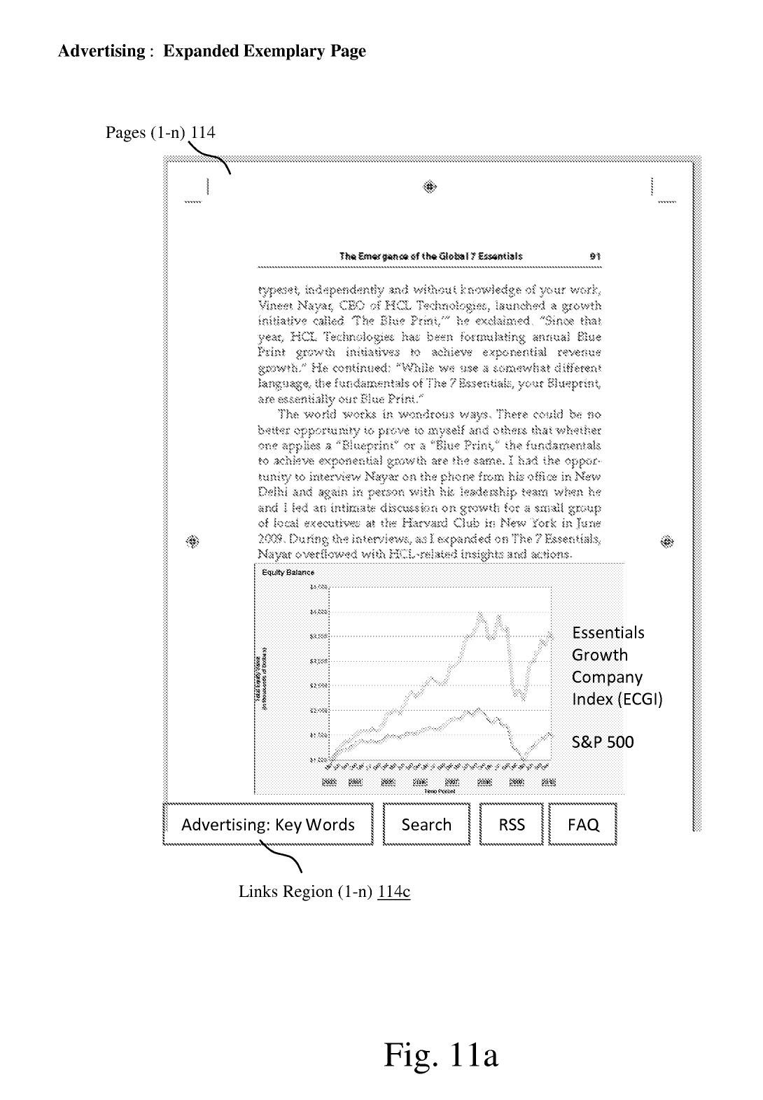

FIG. 11 illustrates a functional diagram for an exemplary advertising in an Active Book System 100.

User Requests a 3^{rd} Party Service from an Advertisement:

In this step, if the User 102 activates a link in the at least one Links Region 114c of the User Interface 112, the Communications Management 110 in Active Book Reader Software 106 generates an aBook Protocol 118 request for a 3^{rd} Party Service 156, and sends the request to an Active Book Server (1-n) 122.

Third Party Services/Advertising Module 134 in Active Book Server 122 sends request to 3^{rd} Party Server 152

In this step, Third Party Services/Advertising Module 134 in the Active Book Server 122 connects to a 3^{rd} Party Server 152 through the Network 120. The Third Party Services/Advertising Module 134 requests to insert advertisements based on agreements between the author/publisher and the third party. After the 3^{rd} Party Service 156 has been completed on the 3^{rd} Party Server 152, the 3^{rd} Party Server 152 sends a confirmation message to the Third Party Services/Advertising Module 134 of the Active Book Server Software 124. The Book Update Module 132 will communicate new advertisers into the book upon the next revision.

In one exemplary aspect, a system and/or method as described herein may provide up-sell revenue opportunities for the author, publisher and other members of the book and services value chain.

FIG. 11a illustrates an expanded view of an example page of advertising in an active book.

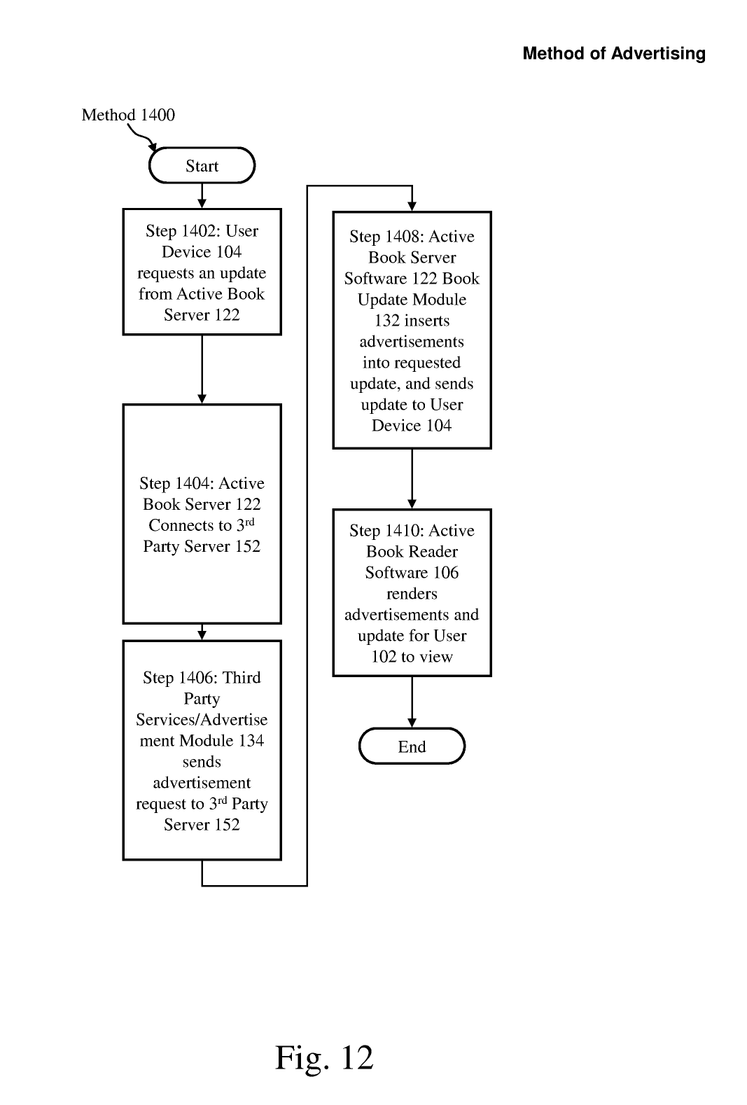

FIG. 12 illustrates a flow diagram for an exemplary method 1200 for creating advertising in an Active Book System 100.

Step 1202: User Device 104 Requests an Update from Active Book Server 122

In this step, Active Book Reader Software 104 Communications Management 110 encodes an update request based on the aBook Protocol 118 and sends the request to an Active Book Server 122 over the Network 120.

### Step 1204: Active Book Server 122 Connects to 3rd Party Server 152

In this step, Active Book Server Software 124 Communications Management Module 126 decodes the update request based on the aBook Protocol 118. The Third Party Services/Advertising Module 134 in the Active Book Server 122 connects to a 3^{rd} Party Server 152 through the Network 120.

### Step 1206: Third Party Services/Advertisement Module 134 Sends Advertisement Request to 3rd Party Server 152

In this step, The Third Party Services/Advertising Module 134 requests to insert advertisements based on agreements between the Active Book Server 122 operator and the 3^{rd} Party Server 152 operator. The 3^{rd} Party Server 152 authorizes the request and sends a confirmation message to the Third Party Services/Advertising Module 134 on the Active Book Server 122.

Step 1208: Active Book Server Software 122 Book Update Module 132 Inserts Advertisements into Requested Update, and Sends Update to User Device 104

In this step, The Book Update Module 132 communicates the advertisements into the requested update. Active Book Server Software 124 Communications Module 126 encodes the requested update using the aBook Protocol 118 and sends the requested update to the User Device 104 over the Network 120.

### Step 1210: Active Book Reader Software 106 Renders Advertisements and Update for User 102 to View

In this step, Active Book Reader Software 106 User Interface 112 renders the advertisement along with the updated book data for the user 102 to view. Method 1200 ends.

### 7. Sharable Notes Using an Active Book System

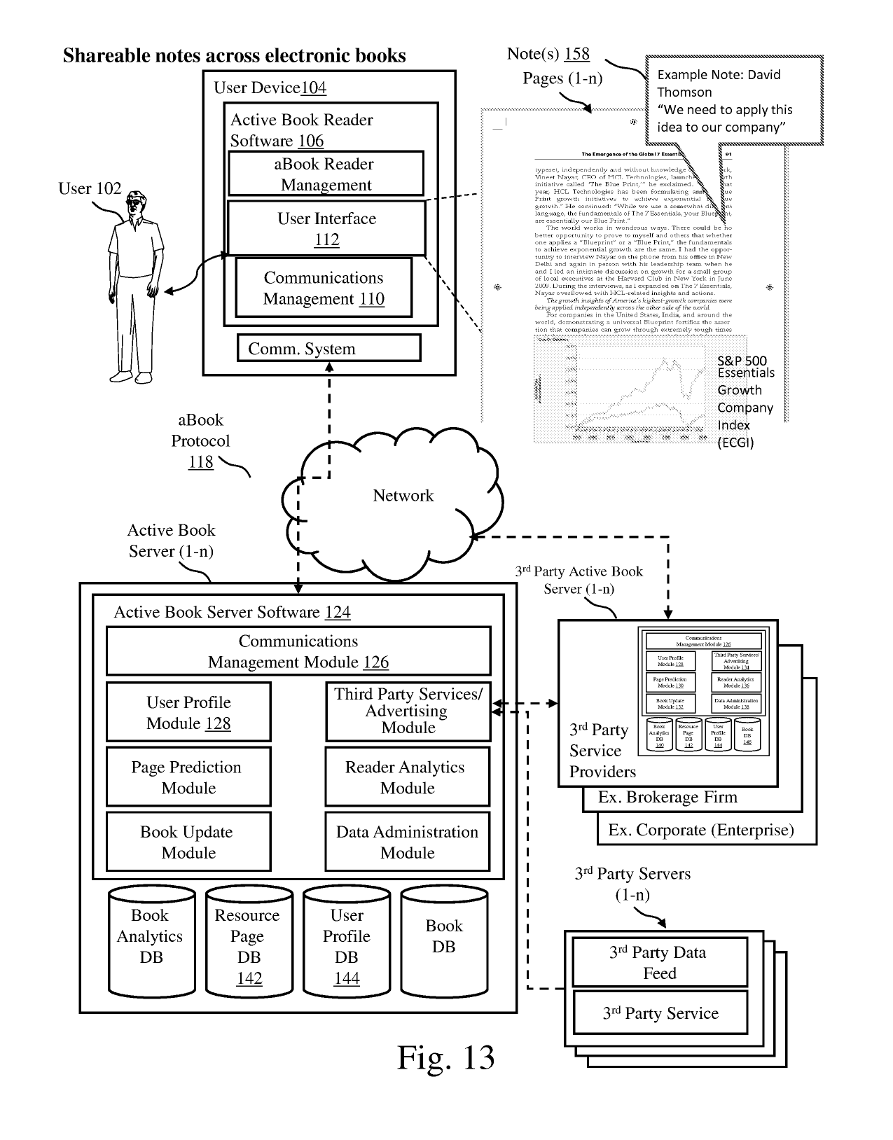

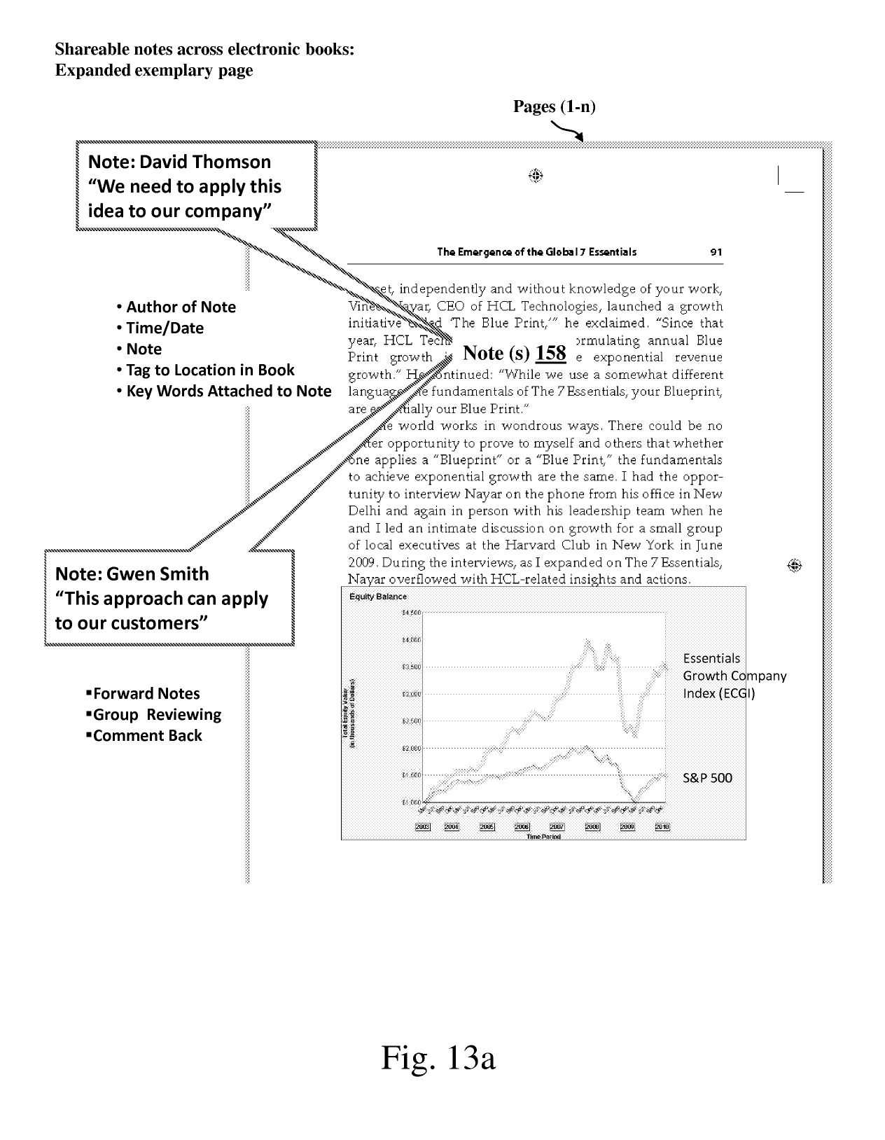

FIG. 13 illustrates a functional diagram for example of shareable notes across electronic books in an Active Book System 100.

The user has the ability to access note features in the Active Book to place note(s) 158 and attach it to a specific word, chart, video or location on the book page. The user then utilizes the keyboard entry capability of the user device 104 to enter text of note(s) 158. In addition, the user may use capabilities of the user device 104 to cut and paste small image blocks into the note(s) 158.

The user has the ability to utilize pop-up menus to forward note(s) 158 to associate or to allow sharing of note(s) 158 with a redefined user group that is stored in the User Profile Database 144. The user's note(s) may be backed up in the Active Server Resource Database 142 to ensure users retain notes in the event of a User Device malfunction.

While the User 102 is reading the current Page (Page 1), the User 102 notices a concept that is particularly relevant and decides to add a note to the page. The User 102 activates a User Interface 112 control which allows them to add a note to the page. When the User 102 finishes writing their note, the user designates that they would like to share the note or all their notes with their associates predefined in the User Profile Database 144 (who are also reading the same book). Information such as the location on the page, the content/text of the note, and/or whether or not the note is shared is encoded by the Communications Management 110 in Active Book Reader Software 106 based on the aBook Protocol 118 and sent to the Active Book Server Software 124. The Communications Management Module 126 in Active Book Server Software 124 decodes the aBook Protocol 118 note data. The Resource Database Module 128 stores this note data. Since the User 102 has elected to share the note, the User Profile Module 128 forwards the note to at least one contact stored in their User Profile in the User Profile Database 144 who also owns an Active Book. In one example, functionality is provided in the User Interface 112 to select recipients from a contact list who own the Active Book in order to send a note to said recipients.

In one exemplary aspect, a system and/or method as described herein may 1) increase the effectiveness of readers to apply ideas and concepts in books, 2) improve team collaboration to extract and advance insights from authored material 3) provide the convenience of rapid communications of insights and actions, and/or 4) encourage other associates to read the same book.

Additionally, electronic note taking in Active Books may offer readers a friendly and productive user interface to capture insights and ideas, the ability to simultaneously share those notes associated with content in the book with associates.

FIG. 13a illustrates an expanded view of an example page of sharing notes across electronic books in an active book.

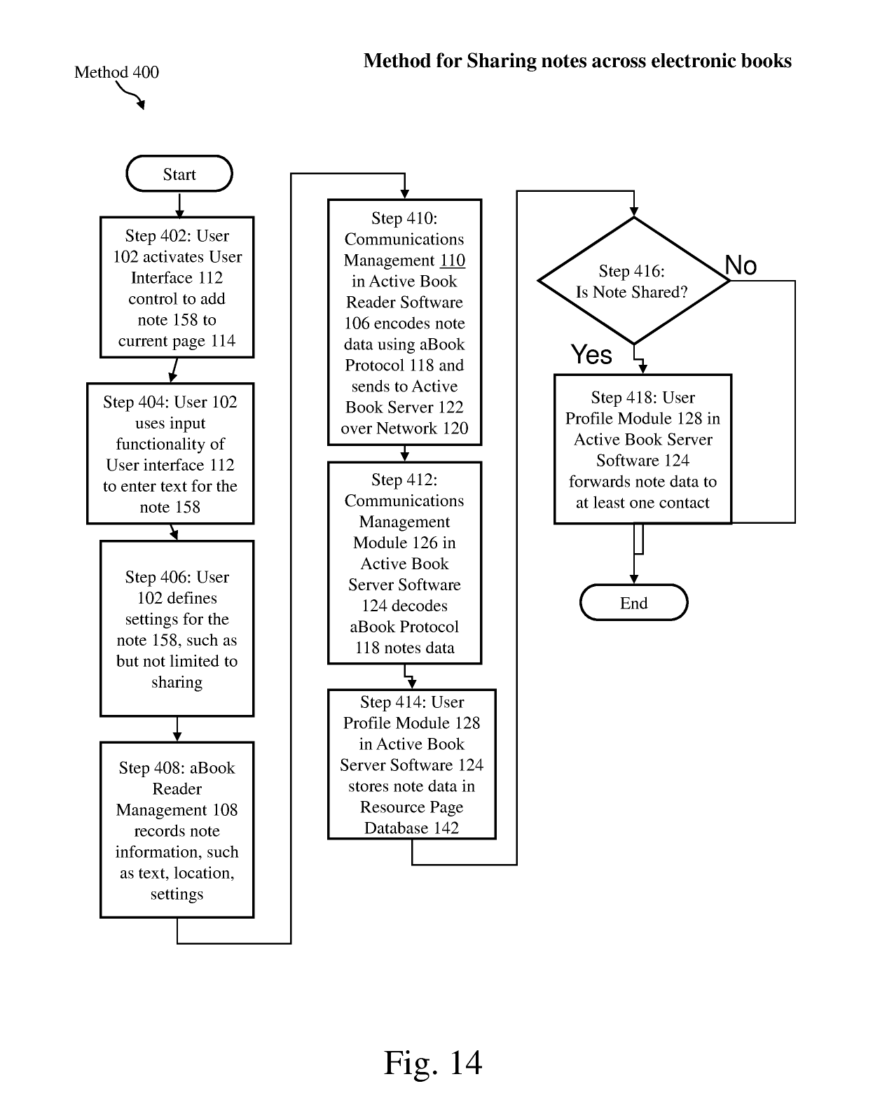

FIG. 14 illustrates a flow diagram for an exemplary method 1400 for sharing notes across electronic books in an Active Book System 100.

### Step 1402: User 102 Activates User Interface 112 Control to Add Note to Current Page

In this step, the User 102 activates a User Interface 112 control, such as but not limited to a menu item, button, or link, which opens a box to add a note to a location on the current page.

### Step 1404: User 102 Uses Input Functionality of User Interface 112 to Enter Content for the Note

In this step, the User 102 uses the input functionality of the User Device 104, such as but not limited to keyboard functionality or cut and paste functionality, to enter the content of the note, which may include text or other media content such as images.

### Step 1406: User 102 Defines Settings for the Note

In this step, the User 102 defines settings for the note, such as but not limited to whether or not the note is shared and who to share the note with.

Step 1408: aBook Reader Management 108 Records Note Information, Such as Text, Location, Settings

In this step, the aBook Reader Management 108 records the note information, such as the content of the note, the location of the note on the page in the Active Book, and the settings for the note.

Step 1410: Communications Management 110 in Active Book Reader Software 106 Encodes Note Data Using aBook Protocol 118 and Sends to Active Book Server 122 Over Network 120

In this step, Communications Management 110 in Active Book Reader Software 106 encodes the note data using the aBook Protocol 118 and sends the note data to an Active Book Server 122 over the Network 120.

Step 1412: Communications Management Module 126 in Active Book Server Software 124 Decodes aBook Protocol 118 Notes Data

In this step, Communications Management Module 126 in the Active Book Server Software 124 decodes the notes data using the aBook Protocol 118.

### Step 1414: User Profile Module 128 in Active Book Server Software 124 Stores Note Data in Resource Page Database 142

In this step, User Profile Module 128 in the Active Book Server Software 124 stores the note data, such as the text of the note, the location of the note in the active book, and any settings associated with the note in the Resource Page Database 142. This backup allows the notes to be preserved in the event of User Device 104 malfunction.

### Step 1416: Is Note Shared?

In this step, if the note is shared, method 400 proceeds to step 418. Otherwise, method 1400 ends.

### Step 1418: User Profile Module 128 in Active Book Server Software 124 Forwards Note Data to at Least One Contact.

In this step, the note data is forwarded by the Active Book Server 122 to the User Device 104 of one or more contacts (who are reading the same book) of the User 102 stored in the User Profile Database 144. The content of the forwarded note may then be displayed in the appropriate location of the Active Book for the at least one contact to view. In one example, the User 102 may select contacts to receive the note from a list of contacts. Method 1400 ends.

### 8. To Share Selective Book or Document Excerpts on Social Media Websites

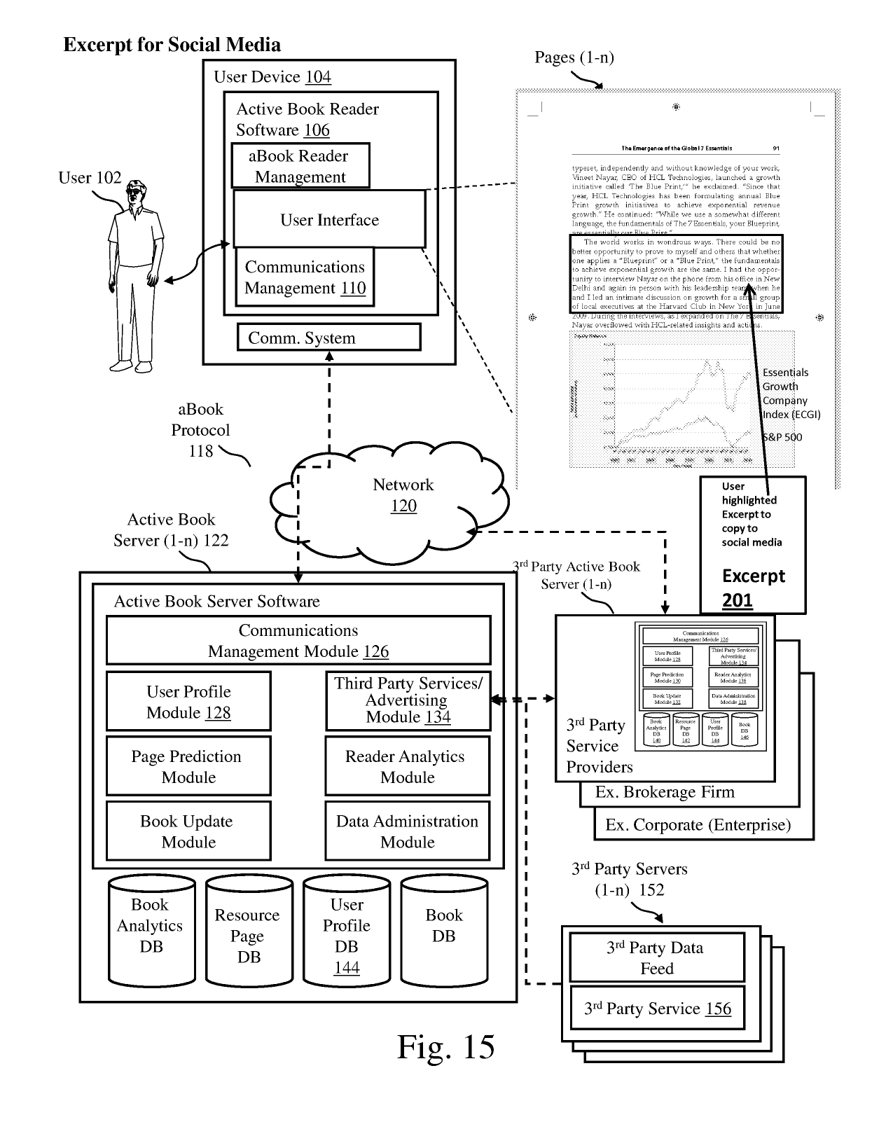

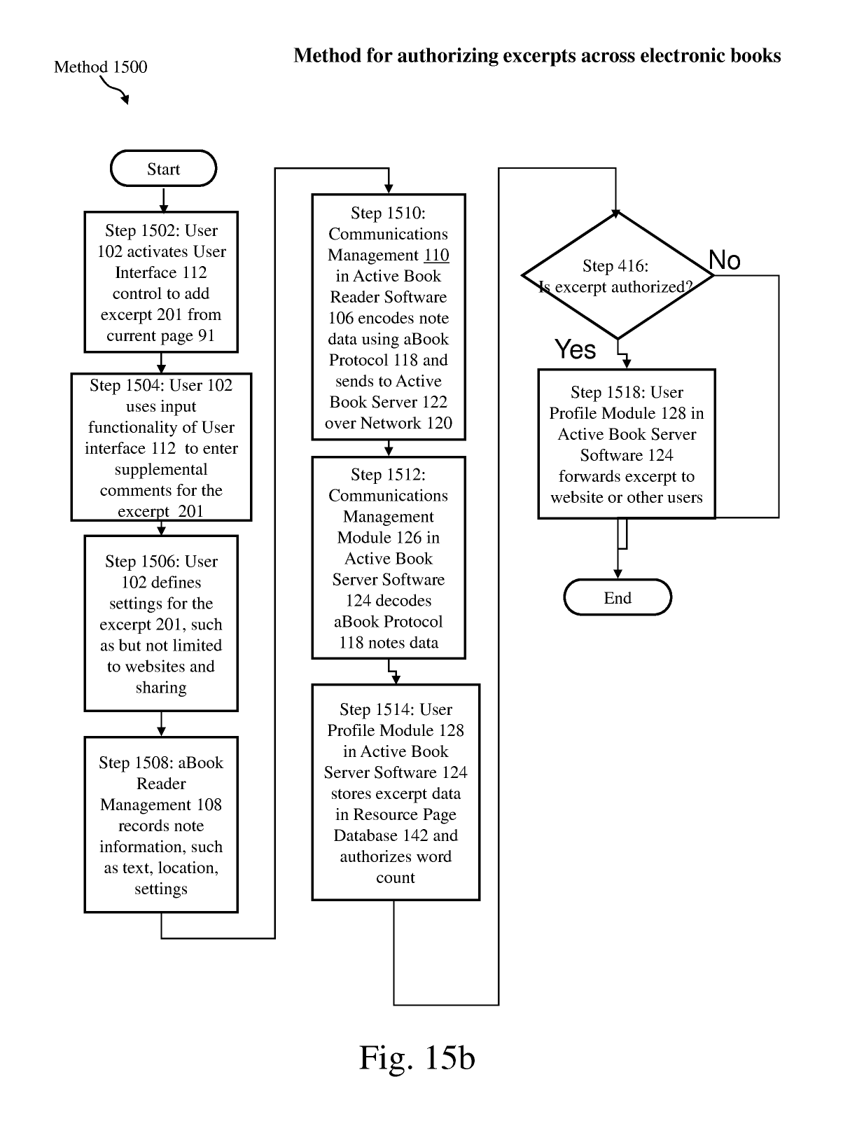

FIG. 15 illustrates a functional diagram for an exemplary Resource Page in an Active Book System 100.

FIG. 15b illustrates a flow diagram for an exemplary method 1500 for sharing notes across electronic books in an Active Book System 100.

The user has the ability to highlight an excerpt from the electronic document being viewed, to place excerpt 201 and attach it to a specific social media or other webpage. The user then utilizes the keyboard entry capability of the user device 104 to enter text of to the excerpt of 201. In addition, the user may use capabilities of the user device 104 to cut and paste small image blocks into the excerpt 201.

In one example, the User Profile Database 144 will count the words to be excerpted and determine if the user is authorized to copy the words or requires payment for additional words. The excerpt rules for the User Profile Database 144 are provided by the Book Update Module 132 and may be predetermined by the author, publisher or representative. The User Profile Database 144 will notify the user device 104 and User interface 112 to provide instructions for the user to authorize payment or accept terms and conditions presented.

In another example, the user has the ability to utilize pop-up menus to forward excerpt 201 to associates through social media websites or to allow sharing of excerpt 201 with a predefined user group that is stored in the User Profile Database 144. The user's excerpt may be backed up in the Active Server Resource Database 142 to ensure users retain notes in the event of a User Device malfunction.

One exemplary implementation will now be described with respect to User 102. While the User 102 is reading the current Page (Page 1), the User 102 notices a concept that is particularly relevant and decides to select an excerpt. The User 102 activates a User Interface 112 control which allows them to add one or more supplemental comments to the selected excerpt. When the User 102 finishes writing their supplemental comments to the excerpt, the user designates that they would like to share the excerpt and/or their comments with their associates predefined in the User Profile Database 144 (who are also reading the same book) or websites. Information such as the location on the page, the content/text of the excerpt, and/or whether or not the excerpt is shared is encoded by the Communications Management 110 in Active Book Reader Software 106 based on the aBook Protocol 118 and sent to the Active Book Server Software 124. The Communications Management Module 126 in Active Book Server Software 124 decodes the aBook Protocol 118 note data. The Resource Database Module 128 stores this excerpt with comments data. Since the User 102 has elected to share the note, the User Profile Module 128 forwards the note to at least one contact or website stored in their User Profile in the User Profile Database 144 who also owns an Active Book. In one example, functionality is provided in the User Interface 112 to select recipients from a contact list who own the Active Book in order to send a note to said recipients.

In one exemplary aspect, a system and/or method as described herein may 1) increase the effectiveness of readers to share ideas and concepts in books, 2) improve team collaboration to extract and advance insights from authored material 3) provide the convenience of rapid communications of insights and actions, and/or 4) encourage other associates to read the same book.

Additionally, electronic excerpts in Active Books may offer readers a friendly and productive user interface to share insightful and interesting content, the ability to simultaneously add comments to engage others in a discussion and to market the book or document to associates through social media websites and pages.

### 9. To Provide Resource Pages Using an Active Book System

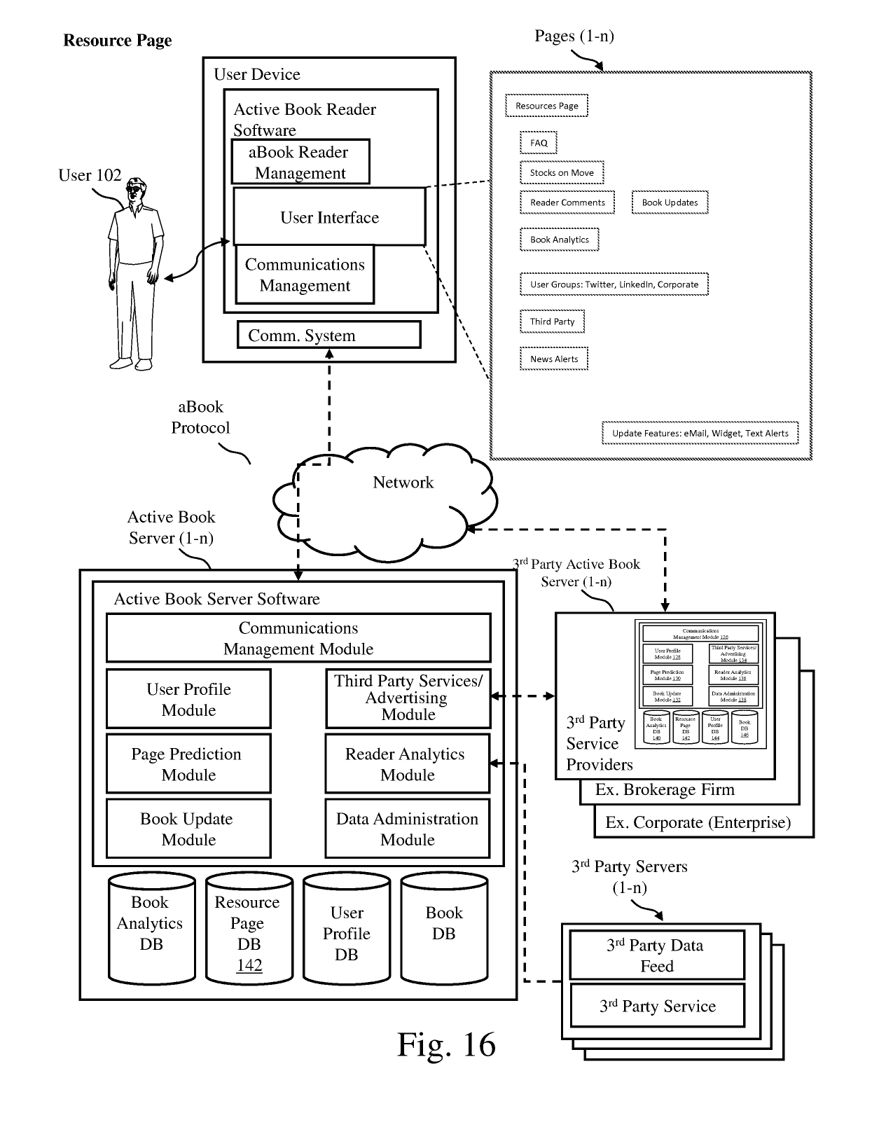

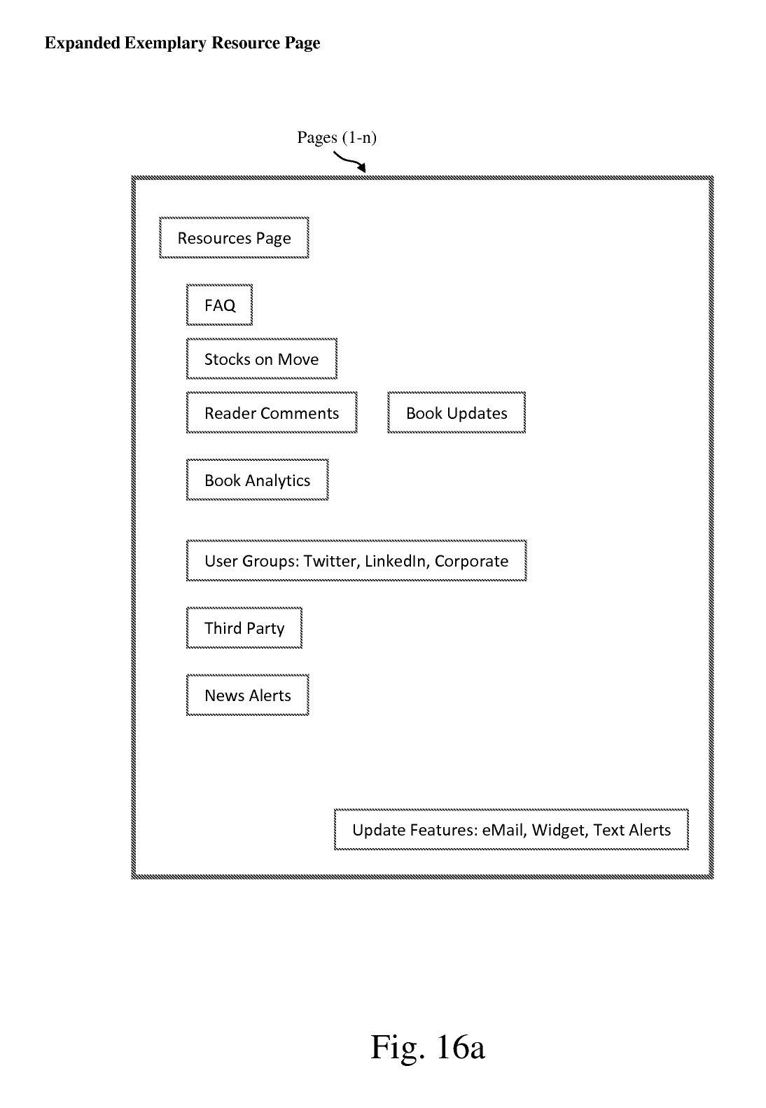

FIG. 16 illustrates a functional diagram for an exemplary Resource Page in an Active Book System 100.

User 102 can cut and paste items on the Resource page and this data can be stored on the Resource database 142.

FIG. 16a illustrates an expanded view of an example page of a resource page in an active book.

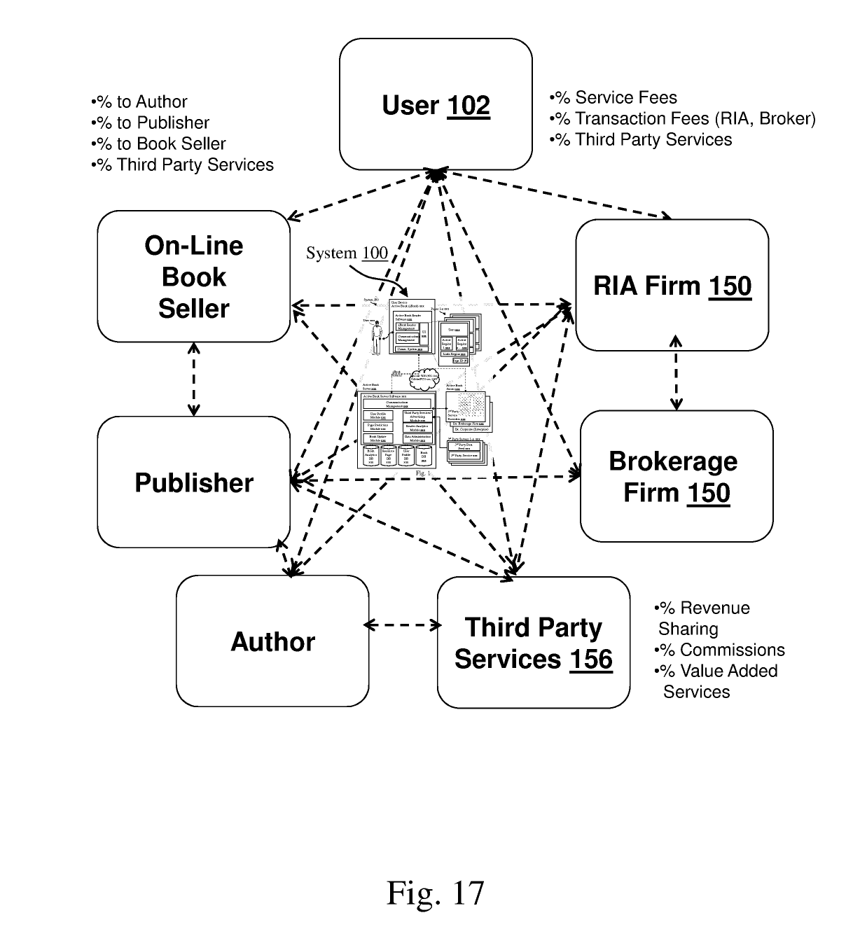

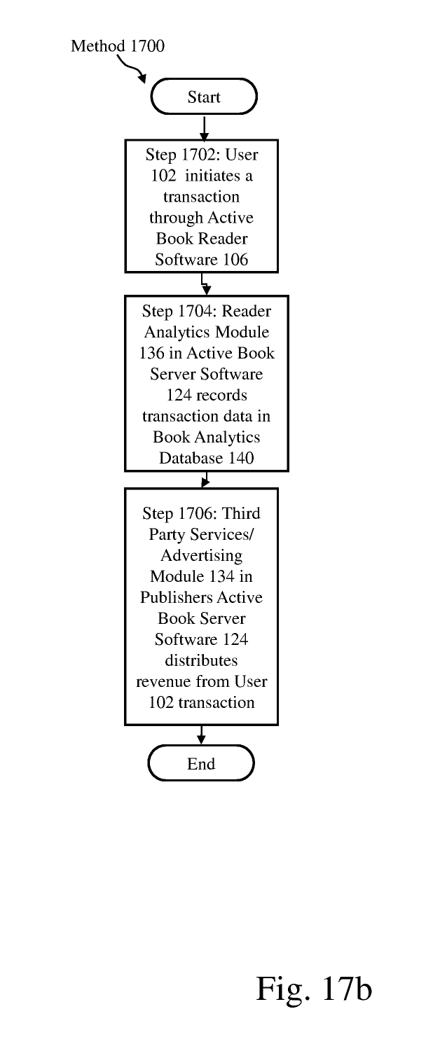

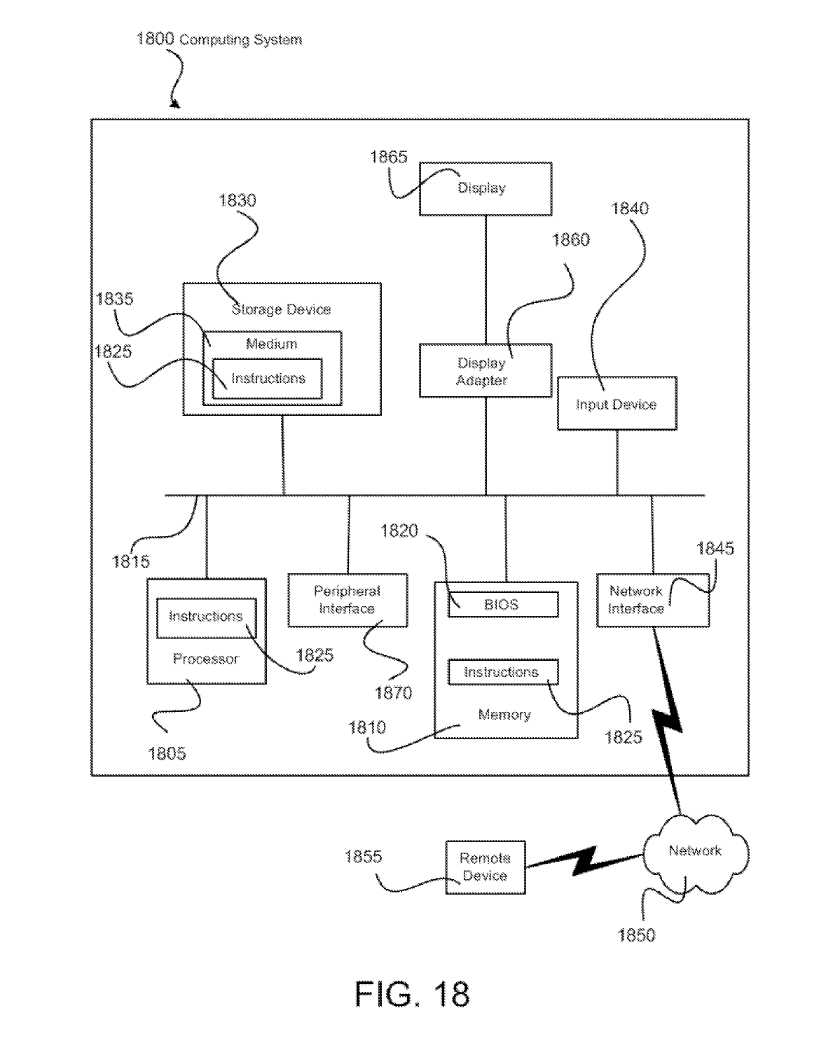

FIG. 17 illustrates a functional diagram for an exemplary business model in an Active Book System 100.

The business model diagram demonstrates the ability for different entities to initiate transactions with one another via Active Book system 100. In this model, each entity has the ability to obtain a value from said transaction. For example, an author has an incentive to revise the book and provide new author services to secure an annuity revenue stream from readers (e.g., users) versus a onetime payment and royalty. On-line Book Sellers can not only secure commissions from the sale of books but can secure commissions from the resale of services from Publishers, Authors, Third Parties, RIAs and Brokerages (as one industry example). Moreover, examples of different types of revenues obtained in said transactions between the abovementioned entities include but are not limited to: % to Author; % to Publisher; % to Book Seller; % Third Party Services; % Service Fees; % Transaction Fees (RIA, Broker); % Third Party Services; % Revenue Sharing; % Commissions; % Value Added Services; and any combinations thereof.

Another embodiment provides opportunity to utilize the Reader Analytics Module 136 of the Active Book Server Software 124 to understand reader behavior in order to develop new services offerings and revenue sharing business models.

For example, User 102 decides to initiate a transaction through an Active Book. After User 102 provides payment information, such as for example credit card or bank information, the Communications Management 110 in Active Book Reader Software 106 encodes a transaction request, such as for example a request for a subscription to data updates or for a brokerage service, based on the aBook Protocol 118 and sends the transaction request to an Active Book Server 122 over Network 120. Active Book Server Software 124 running on Active Book Server 122 authenticates the User 102 using the User Profile Module 128. Active Book Server Software 124 then records data related to the transaction request, such as, for example the parties involved, in the Book Analytics Database 140. The Third Party Services/Advertising Module 134 in the Active Book Server Software 124 then processes the payment for the transaction. Active Book Server Software 124 then executes the transaction request on behalf of the user.

In another implementation, Active Book Server 122 may directly execute the transaction request, such as for example subscribing the User 102 to book updates from said Active Book Server 122. another example, Active Book Server 122 may leverage one or more 3^{rd} Party Active Book Servers 148 to execute the transaction request, such as for example providing brokerage services to the User 102. In yet another example, Active Book Server 122 may leverage one or more 3^{rd} Party Servers (1-n) 152 to execute the transaction request, such as for example, to subscribe a user to data updates from a 3^{rd} Party Data Feed 154. In still another example, Active Book Server 122 may use any combination of the above embodiments to execute the transaction request. Upon completing the transaction request, The Communications Management Module 126 of the Active Book Server Software 124 on Active Book Server 122 would encode a confirmation message based on the aBook Protocol 118 and send the confirmation to User Device 104 over the Network 120. The Third Party Services/Advertising Module 134 in Active Book Server Software 124 would then distribute the collected payment to one or more parties based on a pre-defined agreement.

For example, if a user has paid for a subscription to book and data updates for the Active Book they are reading, a percentage of the payment amount may be paid to one or more parties, such as for example, a royalty to the author, a royalty to the publisher, and a royalty to the data provider. In another example, if a user has requested a brokerage transaction, a percentage of the payment amount may be paid to one or more parties, such as for example, a percentage as a commission to the author, a percentage as a transaction fee to the publisher, and a percentage as a brokerage fee to the brokerage service.

In one exemplary implementation, this partnering approach to business models may create the opportunity for new combinations of partners, revenue sharing and services reselling across industries beyond the financial services example explained above.

FIG. 17b illustrates a flow diagram for an exemplary business method 1700 in an Active Book System 100.

### Step 1702: User 102 Initiates a Transaction Through Active Book Reader Software 106

In this step, A User 102 initiates a transaction through the User Interface 112 of the Active Book Reader Software 106 on their User Device 104. Communications Management 112 in Active Book Reader Software 106 encodes the transaction request using the aBook Protocol 118 and sends the transaction request to Active Book Server 122 over the Network 120. In one example, the transaction may be any financial transaction or purchase, such as for example but not limited to purchasing an Active Book, requesting to buy a stock through a 3^{rd} party service, subscribing to a data update service, and the like.

### Step 1704: Reader Analytics Module 136 in Active Book Server Software 124 Records Transaction Data in Book Analytics Database 140

In this step, Communications Management Module 126 in Active Book Server Software 124 decodes the transaction request. Third Party Services/Advertising Module 134 executes the transaction on behalf of the User 102. Reader Analytics Module 136 records transaction data in Book Analytics Database 140. Communications Management Module 126 in Active Book Server Software 124 encodes confirmation message based on the aBook Protocol 118 and sends confirmation message to User Device 102 over the Network 120. In one implementation, the transaction data may include, for example but not limited to data to identify the parties involved in the transaction and which parties are due a commission or royalty, such as for example but not limited to the author or publisher of an Active Book, the content provider of a data update subscription, or the brokerage firm providing trading services.

Step 1706: Third Party Services/Advertising Module 134 in Publishers Active Book Server Software 124 Distributes Revenue from User 102 Transaction

In this step, Third Party Services/Advertising Module 134 gathers transaction data from the Book Analytics Database 140 and uses an algorithm to determine which 3^{rd} Party Service Providers (1-n) 152 are due a commission or royalty. In one example, this algorithm may determine a commission or royalty rate based on data such as but not limited to the number of copies of an Active Book Sold, the number of users of a data update service, or the volume of trades directed to a brokerage firm. Method 1700 ends.

It is to be noted that any one or more of the aspects and embodiments described herein may be conveniently implemented using one or more machines (e.g., one or more computing devices that are utilized as a user computing device for an electronic document, one or more server devices, such as a document server) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

FIG. 18 shows a diagrammatic representation of one embodiment of a computing device in the exemplary form of a computer system 1800 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Computer system 1800 includes a processor 1805 and a memory 1810 that communicate with each other, and with other components, via a bus 1815. Bus 1815 may include any of several types of bus structures including, but not limited to, a memory bus, a memory controller, a peripheral bus, a local bus, and any combinations thereof, using any of a variety of bus architectures.

Memory 1810 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 1820 (BIOS), including basic routines that help to transfer information between elements within computer system 1800, such as during start-up, may be stored in memory 1810. Memory 1810 may also include (e.g., stored on one or more machine-readable media) instructions (e.g., software) 1825 embodying any one or more of the aspects and/or methodologies of the present disclosure. In another example, memory 1810 may further include any number of program modules including, but not limited to, an operating system, one or more application programs, other program modules, program data, and any combinations thereof.

Computer system 1800 may also include a storage device 1830. Examples of a storage device (e.g., storage device 1830) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 1830 may be connected to bus 1815 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1830 (or one or more components thereof) may be remotely interfaced with computer system 1800 (e.g., via an external port connector (not shown)). Particularly, storage device 1830 and an associated machine-readable medium 1835 may provide nonvolatile and/or volatile storage of machine-readable instructions, data structures, program modules, and/or other data for computer system 1800. In one example, software 1825 may reside, completely or partially, within machine-readable medium 1835. In another example, software 1825 may reside, completely or partially, within processor 1805.

Computer system 1800 may also include an input device 1840. In one example, a user of computer system 1800 may enter commands and/or other information into computer system 1800 via input device 1840. Examples of an input device 1840 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1840 may be interfaced to bus 1815 via any of a variety of interfaces (not shown) including, but not limited to, a serial interface, a parallel interface, a game port, a USB interface, a FIREWIRE interface, a direct interface to bus 1815, and any combinations thereof. Input device may include a touch screen interface that may be a part of or separate from display 1865, discussed further below.

A user may also input commands and/or other information to computer system 1800 via storage device 1830 (e.g., a removable disk drive, a flash drive, etc.) and/or a network interface device 1845. A network interface device, such as network interface device 1845 may be utilized for connecting computer system 1800 to one or more of a variety of networks, such as network 1850, and one or more remote devices 1855 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1850, may employ a wired and/or a wireless mode of communication. In general, any network topology may be used. Information (e.g., data, software 1825, etc.) may be communicated to and/or from computer system 1800 via network interface device 1845.

Computer system 1800 may further include a video display adapter 1860 for communicating a displayable image to a display device, such as display device 1865. Examples of a display device include, but are not limited to, a liquid crystal display (LCD), a cathode ray tube (CRT), a plasma display, a light emitting diode (LED) display, and any combinations thereof. In addition to a display device, a computer system 1800 may include one or more other peripheral output devices including, but not limited to, an audio speaker, a printer, and any combinations thereof. Such peripheral output devices may be connected to bus 1815 via a peripheral interface 1870. Examples of a peripheral interface include, but are not limited to, a serial port, a USB connection, a FIREWIRE connection, a parallel connection, and any combinations thereof.

In one example, an electronic document may be downloaded from a remote server, such as remote device 1855 to storage device 1830. A user may access the electronic document using input device 1840 and be provided a display utilizing display 1865. The display of the electronic document may be facilitated by a reader application including machine executable instructions stored in memory 1835 of storage device 1830. Active interaction with one or more portions of an electronic document may occur via network 1850 using an active document protocol stored in memory 1835 and implemented using processor 1805 to update and/or otherwise interact with one or more portions of the electronic document using information from remote device 1855. Other implementations using a computing device such as computing device 1800 will be apparent to those of ordinary skill from the disclosure herein.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of modifying an electronic file, the method comprising:
connecting a computing device having the electronic file via a network to a remote service that contains a master copy of the electronic file;
restricting accessibility of data, information, knowledge or content in the electronic file with a rights management system;
identifying one or more subsets of the data, information, knowledge or content in the document electronic file to be modified;
providing or receiving via the network updated data, information, knowledge or content for the one or more subsets;
modifying the one or more subsets with the updated data, information, knowledge or content without modifying the entire electronic file;
wherein the data, information, knowledge or content conveys or denotes meaning to at least one computer or consumer of the data, information, knowledge or content when given exposure directly or indirectly to the electronic file in digital of non-digital form;
wherein the computing device comprises a tangible article and processes instruction it receives from a computer readable medium;
wherein the remote service comprises server based data, information, knowledge or content and services needs or requests;
wherein the network connects, adjoins, or spans the server and the computing device through wireless means, wired means or some combination thereof; and
wherein the modifying of one or more subsets includes changing, revising, updating, augmenting or deletion of one or more subsets.

2. A method according to claim 1, further comprising outputting information to a user or the network.

3. A method according to claim 1, further comprising assigning the electronic file a unique identification number.

4. A method according to claim 3, where in the unique identification number is an ISBN or International Standard Book Number.

5. A method according to claim 1, wherein the electronic file is a PDF or Portable Document Format file.

6. A method according to claim 1, further comprising including copyrighted information in the electronic file.

7. A method according to claim 1, further comprising maintaining the service or server remote from the computing device.

8. A method according to claim 1, wherein restricting accessibility restricts the copying or redistribution of the electronic file.

9. A method according to claim 1, wherein restricting accessibility permits only predetermined entities to modify the information in the electronic file.

10. A method according to claim 1, further comprising including the updated data, information, knowledge or content in a particular bit pattern format that allows secure authentication for the providing of data, information, knowledge or content between the computing device and the remote service.

11. A method according to claim 1, further comprising gathering reader viewing statistics of the electronic file.

12. A method according to claim 11, further comprising reporting the reader viewer statistics via the network to the remote service.

13. A method according to claim 1, further comprising activating as part of the electronic file, in exchange for additional payment, at least one of a subscription to information services, a supplemental piece of information, active services, a purchase of products or services, or any combination thereof.

14. A method according to claim 1, further comprising providing an option to a user to share user-generated notes specific to the electronic file with other computing devices.

15. A method according to claim 14, further comprising determining the other computing devices are authorized to contain the electronic file prior to providing the user-generated notes.

16. A method according to claim 14, further comprising providing only the user-generated notes to the other computing device.

17. A method according to claim 14, further comprising displaying the user-generated notes on the other computing device in a location that correlates to a location in the electronic file where the notes were generated.

18. A method according to claim 1, further comprising providing business rules for user-selected data, information, knowledge or content that is shared with a social network service.

19. A non-transitory machine-readable storage medium with machine executable instructions configured to modify an electronic file, the instructions including:
set of instructions configured to connect a computing device having the electronic file via a network to a remote service that contains a master copy of the electronic file;
set of instructions configured to restrict accessibility of data, information, knowledge or content in the electronic file with a rights management system;
set of instructions configured to identify one to more subsets of the data, information, knowledge or content in the electronic file to be modified;
set of instructions configured to provide or receive via the network updated data, information, knowledge or content for the one or more subsets;
set of instructions configured to modify the one or more subsets with updated data, information, knowledge or content without modifying the entire electronic file;
wherein the data, information, knowledge or content conveys or denotes meaning to at least one computer or consumer of data, information, knowledge or content when given exposure directly or indirectly to the electronic file in digital or non-digital form;
wherein the remote service comprises of server-based data, information, knowledge or content and service needs or requests;
wherein the network connects, adjoins, or spans the server and the computing device through wireless means, wired means or some combination thereof; and
wherein the modifying of one or more of the subsets includes changing, revising, updating, augmenting or deletion of one or more of the subsets.

20. A system according to claim 19, wherein the electronic file is assigned a unique identification number.

21. A system according to claim 20, wherein the unique identification number is an ISBN.

22. A system according to claim 19, wherein the electronic file is a PDF or Portable Document Format file.

23. A system according to claim 19, wherein the electronic file includes copyright information.

24. A system according to claim 19, wherein the service or server is maintained remote from the computing device.

25. A system according to claim 19, wherein the instructions configured to restrict accessibility restricts the copying or redistribution of the electronic file.

26. A system according to claim 19, wherein the instructions configured to restrict accessibility permits only predetermined entities to modify the information in the electronic file.

27. A system according to claim 19, wherein the updated data, information, knowledge or content is provided in a particular bit pattern format that allows secure authentication for the exchange of data, information, knowledge or content between the computing device and the remote service.

28. A system according to claim 19, further comprising a set of instructions configured to gather reader viewing statistics of the electronic file.

29. A system according to claim 19, further comprising a set of instructions configured to report the reader viewing statistics to the remote service.

30. A system according to claim 19, further comprising a set of instructions configured to activate as part of the electronic file, in exchange for additional payment, at least one of a subscription to information services, a supplemental piece of information, active services, a purchase of products or services, or any combination thereof.

31. A system according to claim 19, further comprising a set of instructions configured to provide an option to a user to share user-generated notes specific to the electronic file with other computing devices.

32. A system according to claim 31, further comprising a set of instructions configured to determining the other computing devices are authorized to contain the electronic file prior to providing the user-generated notes.

33. A system according to claim 31, further comprising a set of instructions configured to provide only the user-generated notes to the other computing device.

34. A system according to claim 31, further comprising a set of instruction configured to display the user-generated notes on the other computing device in a location that correlates to a location in the electronic file where the notes were generated.

35. An electronic file modification system, the system comprising:
a means for connecting a computer device having the electronic file via a network to a remote service that contains a master copy of the electronic file;
a means for restricting accessibility of data, information, knowledge or content in the electronic file with a rights management system;
a means for identifying the subset of the data, information, knowledge or content in the electronic file to be modified;
a means for providing or receiving via a network a set of updated data, information, knowledge or content for the one or more subsets; and
a means for modifying the one or more subsets with the updated data, information, knowledge or content without modifying the entire electronic file;
wherein the data, information, knowledge or content conveys or denotes meaning to at least one computer or consumer of the data, information, knowledge or content when given exposure directly or indirectly to the electronic file in digital or non-digital form;
wherein the remote service comprises server-based data, information, knowledge or content and services needs or requests;
wherein the network connects, adjoins, or spans the server and the computing device through wireless means, wired means or some combination thereof; and
wherein the modifying of one or more subsets includes changing, revising, updating, augmenting or deletion of one or more subsets.

36. A system according to claim 35, wherein the electronic file is assigned a unique identification number.

37. A system according to claim 36, wherein the unique identification number is an ISBN.

38. A system according to claim 35, wherein the electronic file is a PDF or Portable Document Format file.

39. A system according to claim 35, wherein the electronic file includes copyrighted information.

40. A system according to claim 35, wherein the service or server is maintained remote from the computing device.

41. A system according to claim 35, wherein the means for restricting accessibility permits only predetermined entities to modify the information in the electronic file.

42. A system according to claim 35, wherein the updated data, information, knowledge or content is provided in a particular bit pattern format that allows secure authentication for the exchange of data, information, knowledge or content between the computing device and the remote service.

43. A system according to claim 35, further comprising a means for gathering reader viewing statistics of the electronic file.

44. A system according to claim 43, further comprising a means for reporting the reader viewing statistics to the remote service.

45. A system according to claim 35, further comprising a means for activating as part of the electronic file, in exchange for additional payment, at least one of a subscription to information services, a supplemental piece of information, active services, a purchase of products or services, or any combination thereof.

46. A system according to claim 35, further comprising a means for providing an option to a user to share user-generated notes specific to the electronic file with other computing devices.

47. A system according to claim 46, further comprising a means for determining the other computing devices are authorized to contain the electronic file prior to providing the user-generated notes.

48. A system according to claim 47, further comprising a means for providing only the user-generated notes to the other computing device.

49. A system according to claim 47, further comprising a means for displaying the user-generated notes on the other computing device in a location that correlates to a location in the electronic file where the notes were generated.

50. A method of supplementing an electronic file with third-party or value-added services, the method comprising:
connecting a computing device having the electronic file via a network to a remote service that contains a master copy of the electronic file;
identifying one or more third-party sets of data, information, knowledge or content to supplement the electronic file;
providing a user with an option of a fee-based transaction for the third-party sets of data, information, knowledge or content;
providing via the network the one or more third-party sets of data, information, knowledge or content;
adding the one or more third-party sets of information without replacing or altering the entire electronic file;
wherein the data, information, knowledge or content conveys or denotes meaning to at least one computer or consumer of the data, information, knowledge or content when given exposure directly or indirectly to the electronic file in digital of non-digital form;
wherein the computing device comprises a tangible article and processes instruction it receives from a computer readable medium;
wherein the remote service comprises server based data, information, knowledge or content and services needs or requests;
wherein the network connects, adjoins, or spans the server and the computing device through wireless means, wired means or some combination thereof; and
wherein the modifying of one or more subsets includes changing, revising, updating, augmenting, deletion or excerpts of one or more subsets.

51. A method according to claim 50, further comprising assigning the electronic file a unique identification number.

52. A method according to claim 51, where in the unique identification number is an ISBN or International Standard Book Number.

53. A method according to claim 50, wherein the electronic file is a PDF or Portable Document Format file.

54. A method according to claim 50, further comprising including copyrighted information in the electronic file.

55. A method according to claim 50, further comprising maintaining the service or server remote from the computing device.

56. A method according to claim 50, further comprising restricting the copying or redistribution of the electronic file.

57. A method according to claim 56, wherein the restricting permits only predetermined entities to modify the information in the electronic file.

58. A method according to claim 50, further comprising including the updated data, information, knowledge or content in a particular bit pattern format that allows secure authentication for the providing of data, information, knowledge or content between the computing device and the remote service.

59. A method according to claim 50, further comprising gathering reader viewing statistics of the electronic file.

60. A method according to claim 59, further comprising reporting the reader viewer statistics via the network to the remote service.

61. A method according to claim 50, further comprising including in the one or more third-party sets of information at least one of updated textual files, graphical files, audio files, video files or some combination thereof.

62. A method according to claim 50, further comprising providing an option to a user to share user-generated notes specific to the electronic file with other computing devices.

63. A method according to claim 62, further comprising determining the other computing devices are authorized to contain the electronic file prior to providing the user-generated notes.

64. A method according to claim 62, further comprising providing only the user-generated notes to the other computing device.

65. A method according to claim 62, further comprising displaying the user-generated notes on the other computing device in a location that correlates to a location in the electronic file where the notes were generated.

66. A method according to claim 50, further comprising providing business rules for user-selected data, information, knowledge or content that is shared with a social network service.

67. A method according to claim 50, further comprising outputting information to a user or the network.
